(19) United States
(12) Patent Application Publication
(10) Pub. No.: US 2014/0201367 A1
(43) Pub. Date: Jul. 17, 2014

(54) LOCATION-BASED COMMUNICATION AND INTERACTION SYSTEM

(71) Applicant: Social Order, LLC, Las Vegas, NV (US)

(72) Inventors: Marcus Trummer, Las Vegas, NV (US); Patrick Beard, Westlake Village, CA (US); Mike Johnson, Moorpark, CA (US)

(73) Assignee: Social Order, LLC, Las Vegas, NV (US)

(21) Appl. No.: 14/137,670

(22) Filed: Dec. 20, 2013

Related U.S. Application Data
(60) Provisional application No. 61/753,825, filed on Jan. 17, 2013.

(51) Int. Cl. H04L 29/08

(52) U.S. Cl. CPC H04L 67/16
USPC 709/225

(57) ABSTRACT

A system comprising a database containing first and second location elements, a feature set, and a first unique identifier associated with the second location element; a system controller coupled to the database and configured to establish the first location element with a first physical location, establish the second location element with a second physical location and associate the first unique identifier with the second location element; and a user interface coupling a first user device with the system controller, the first user device associated with the first location element; and the system controller being further configured to transmit an initiated action between the first and second user, to transmit the unique identifier to the first user in relation to the action from the second user, and to associate the first user with the second location element based on the possession of the unique identifier by the first user after transmission.

### CROSS REFERENCE TO RELATED APPLICATIONS

This application claims the benefits of U.S. Provisional Application No. 61/753,825 entitled SOCIAL ORDER APPLICATION, and filed on Jan. 17, 2013, the entirety of which is incorporated herein by reference.

This application is related to and incorporates by reference related U.S. Non-Provisional application Ser. No. (N/A) entitled SYSTEM AND METHOD OF PROVIDING COMMUNICATION RECOMMENDATIONS (Attorney Docket No. 060518.00008) filed on Dec. 20, 2013, U.S. Non-Provisional application Ser. No. (N/A) entitled SOCIAL INTELLIGENCE SYSTEM AND METHOD (Attorney Docket No. 060518.0009) filed on Dec. 20, 2013, and U.S. Non-Provisional application Ser. No. (N/A) entitled SYSTEM AND METHOD OF GENERATING MICRO-SOCIAL ENVIRONMENTS (Attorney Docket No. 060518.0010) filed on Dec. 20, 2013.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The invention generally relates to systems and methods for defining and generating interactive geospatial features, including user interaction and venue related features, as well as managing various social iterations between users and between users and the venue within a provided space.

### BACKGROUND OF THE INVENTION

Previously, venues depended on many non-digital mechanisms in order to manage client interactions and vendor transactions. Venues in this context may be defined as nightclubs, bars, resorts, restaurants, cruise ships, lounges, stadiums, festivals, bowling alleys, malls, or similar entertainment or gathering places with definable geographic locations. Such venues may also include committable areas, which may involve VIP sections, private parties, promotional sections, or any additional type of subsection with additional differentiating elements.

With such venues, promoters manage an influx of patrons through guest lists and admission counts. Bartenders and wait staff attend all client requests through traditional point of sale systems. Finally, services to committable areas would operate through traditional means of physical security and constant communication between the staff and the committable area patrons. These methods would often lead to miscommunication, confusion and missed sales opportunities when staff could not attend to these areas on a busy night.

Between the patrons themselves, traditional methods of communications and interactions are now augmented by many social media technologies such as Twitter, Facebook, and Foursquare. Unfortunately, these social media platforms lack the ability to modify themselves to the space or metrics of a particular venue. Furthermore, these platforms lack the ability for the patrons to interact directly with the venue in order to request particular services, such as drinks, food, or additional guest services.

The present invention is aimed at one or more of the problems identified above.

### BRIEF SUMMARY OF INVENTION

In one aspect of the aspect of the present invention, a system for generating location-based communication and interaction features is provided. The system includes a database, a system controller coupled to the database, and a user interface configured to couple a first user device with the system controller. The database includes a first and second location element, a feature set, and a first unique identifier associated with the second location element. The system controller is configured to establish the first location element with a first physical location establish the second location element with a second physical location and associate the first unique identifier with the second location element. The user interface is configured to couple a first user device with the system controller. The first user device being associated with the first location element, then the system controller is further configured to transmit an initiated action between the first and second user, transmit the unique identifier to the first user in relation to the action from the second user, and associate the first user with the second location element based on the possession of the unique identifier by the first user after transmission.

In another aspect of the present invention, a method of generating location-based communication and interaction features including a database, a system controller, a first user interface, and a second user interface is provided. The database further includes a first and second location element, a feature set including one action, and a first unique identifier associated with the second location element. The method comprises the steps of: establishing the first location element with a first physical location through the system controller; associating the first location element with a first user interface; association the second location with a second user interface; coupling the first user device with the system controller through the user interface; coupling the second user device with the system controller through the user interface; transmitting an action from within the feature set between the first user and the second user; transmitting the unique identifier to the first user in relation to the response to the action from the second user; and granting the user of the first user device access to the second feature set and the second location element based on the association with the first unique identifier. In another aspect of the present invention, a method where each feature set further includes a plurality of features is provided. The method further includes the step of allowing an administrator to modify the number of features from the first and second feature sets.

In another aspect of the present invention, a non-transitory information recording medium on which a computer readable program is recorded that causes a computer to function as a system for generating location-based communication and interaction features is provided. The system includes a database, a system controller coupled to the database, and a user interface configured to couple a first user device with the system controller. The database includes a first and second location element, a feature set, and a first unique identifier associated with the second location element. The system controller is configured to establish the first location element with a first physical location establish the second location element with a second physical location and associate the first unique identifier with the second location element. The user interface is configured to couple a first user device with the system controller. The first user device being associated with the first location element, then the system controller is further configured to transmit an initiated action between the first and second user, transmit the unique identifier to the first user in relation to the action from the second user, and associate the first user with the second location element based on the possession of the unique identifier by the first user after transmission.

### BRIEF DESCRIPTION OF THE DRAWINGS

Other advantages of the present invention will be readily appreciated as the same becomes better understood by reference to the following detailed description when considered in connection with the accompanying drawings:

FIG. 1 is a diagram of a system for implementing social interaction systems and methods, according to various embodiments of the present invention.

FIG. 2 is a perspective view of an exemplary environment utilizing the system of FIG. 1.

FIG. 3 is a flowchart of a method for generating location-based communication and interaction features (Social Migration), according to an embodiment of the present invention.

FIG. 4 is a flowchart of a method for recommending communication actions within a relationship-based system (Progressive Socialization), according to an embodiment of the present invention.

FIG. 5 is a flowchart of a method for generating user metrics based on social data (Social Intelligence), according to an embodiment of the present invention.

FIG. 6 is a flowchart of a method for generating micro-social environments (Micro-Social Environments), according to an embodiment of the present invention.

FIG. 7 is a flow diagram of a user interface within an embodiment of the present invention that particularly details the account and venue elements of the detailed embodiment.

FIG. 8 is a flow diagram of a user interface within an embodiment of the present invention that particularly details the socialization elements of the detailed embodiment.

FIG. 9 is a flow diagram of a user interface within an embodiment of the present invention that particularly details the order elements of the detailed embodiment.

FIG. 10 is a flow diagram of a user interface within an embodiment of the present invention that particularly details the drink purchase elements of the detailed embodiment.

FIG. 11 is a flow diagram of a user interface within an embodiment of the present invention that particularly details the drink offer socialization elements of the detailed embodiment.

FIG. 12 is a flow diagram of a user interface within an embodiment of the present invention that particularly details the ‘meet up’ socialization elements of the detailed embodiment.

FIG. 13 is a flow diagram of a user interface within an embodiment of the present invention that particularly details the ‘wink’ gestural socialization elements of the detailed embodiment.

FIG. 14 is a flow diagram of a user interface within an embodiment of the present invention that particularly details the ‘invite’ socialization elements of the detailed embodiment.

FIG. 15 is a flow diagram of a user interface within an embodiment of the present invention that particularly details the ‘get invited’ socialization elements of the detailed embodiment.

FIG. 16 is an illustrative screenshot of the administrative panel landing page within an embodiment of the present invention.

FIG. 17 is an illustrative screenshot of the administrative panel users screen within an embodiment of the present invention.

FIG. 18 is an illustrative screenshot of the administrative panel accounts dashboard within an embodiment of the present invention.

FIG. 19 is an illustrative screenshot of the administrative panel venues screen within an embodiment of the present invention.

FIG. 20 is an illustrative screenshot of the administrative panel ‘create venue’ screen within an embodiment of the present invention.

FIG. 21 is an illustrative screenshot of the administrative panel ‘view venue details’ screen within an embodiment of the present invention.

FIG. 22 is an illustrative screenshot of the administrative panel ‘edit venue’ screen within an embodiment of the present invention.

FIG. 23 is an illustrative screenshot of the administrative panel ‘create table/cabana’ screen within an embodiment of the present invention.

FIG. 24 is an illustrative screenshot of the administrative panel ‘create physical location’ screen within an embodiment of the present invention.

FIG. 25 is an illustrative screenshot of the administrative panel ‘create promo codes’ screen within an embodiment of the present invention.

FIG. 26 is an illustrative screenshot of the administrative panel ‘Items’ screen within an embodiment of the present invention.

FIG. 27 is an illustrative screenshot of the administrative panel ‘Specials’ screen within an embodiment of the present invention.

FIG. 28 is an illustrative screenshot of the administrative panel ‘Create Announcement Offer’ screen within an embodiment of the present invention.

FIG. 29 is an illustrative screenshot of the administrative panel ‘Favorite Drinks’ screen within an embodiment of the present invention.

FIG. 30 is an illustrative screenshot of the administrative panel ‘Create Favorite Drink’ screen within an embodiment of the present invention.

FIG. 31 is an illustrative screenshot of the administrative panel ‘Order Details’ screen within an embodiment of the present invention.

FIG. 32 is an illustrative screenshot of the administrative panel ‘GoMingle’ landing screen within an embodiment of the present invention.

FIG. 33 is an illustrative screenshot of the administrative panel ‘Create Email’ screen within an embodiment of the present invention.

FIG. 34 is an illustrative screenshot of the administrative panel ‘Terms & Conditions’ screen within an embodiment of the present invention.

FIG. 35 is an illustrative screenshot of the administrative panel ‘Create Terms & Conditions’ screen within an embodiment of the present invention.

FIG. 36 is an illustrative screenshot of the administrative panel ‘Forgot Password’ screen within an embodiment of the present invention.

FIG. 37 is an illustrative screenshot of the administrative panel ‘Change Password’ screen within an embodiment of the present invention.

FIG. 38 is a diagram of the accounts module within an embodiment of the present invention.

FIG. 39 is a diagram of the venues module within an embodiment of the present invention.

FIG. 40 is a diagram of the community module within an embodiment of the present invention.

FIG. 41 is a diagram of the user and order module within an embodiment of the present invention.

FIG. 42 is a diagram of the model view relationship within an embodiment of the present invention.

FIG. 43 is a diagram of the view relationship within an embodiment of the present invention.

FIG. 44 is an alternate diagram of the view relationship within an embodiment of the present invention.

FIG. 45 is an alternate diagram of the view relationship within an embodiment of the present invention.

Corresponding reference characters indicate corresponding parts throughout the drawings.

### DETAILED DESCRIPTION OF THE INVENTION

With reference to the drawings and in operation, the present invention overcomes some of the disadvantages of the known prior art by providing systems and methods for generating location-based communication and interaction features.

A selected embodiment of the present invention will now be explained with reference to the drawings. It will be apparent to those skilled in the art from this disclosure that the following description of the embodiments of the present invention is provided for illustration only and not for the purpose of limiting the invention as defined by the appended claims and their equivalents.

Referring to the figures, where like numerals indicate like or corresponding parts throughout the several views, the systems and methods are constructed in accordance with the invention and configured for providing for generating location-based communication and interaction features.

### System Generally

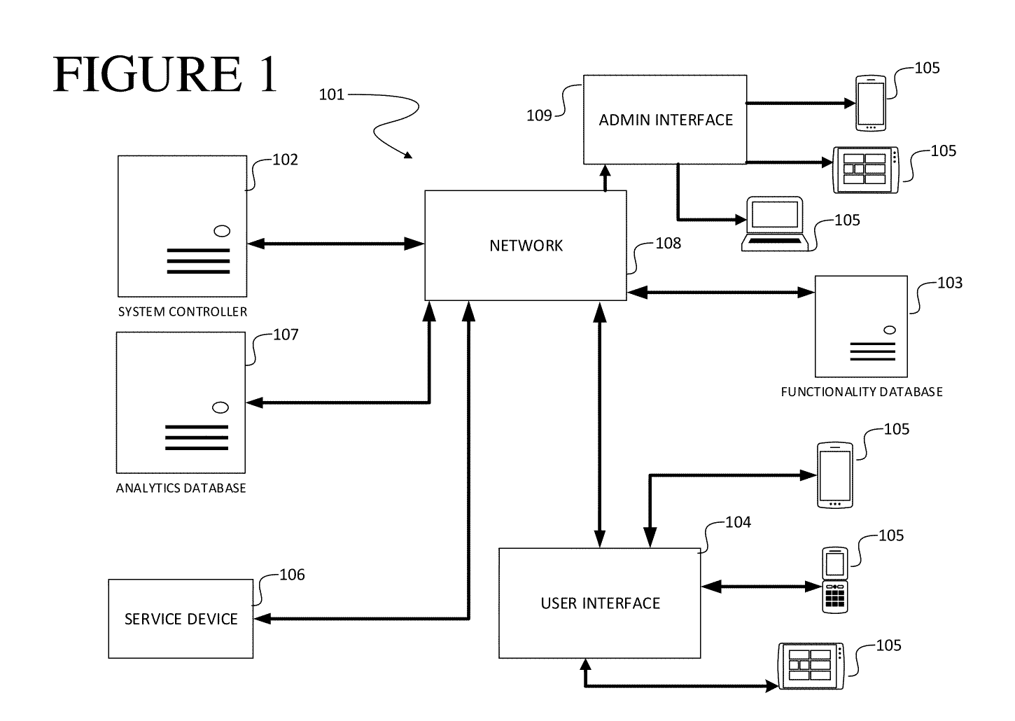

FIG. 1 is a schematic view of an exemplary system 101, which allows for location-based interactions between users and the system within a venue. A venue in this context may be defined as nightclubs, bars, resorts, restaurants, cruise ships, lounges, stadiums, festivals, bowling alleys, malls, or similar entertainment or gathering places with definable geographic locations. Such venues may also include committable areas, which may involve VIP sections, private parties, promotional section, or any additional type of subsection with additional differentiating elements.

In the illustrated embodiment, the system 101 includes a system controller 102, functionality database 103, a user interface 104, an analytics database 107, and an admin interface 109. The system 101 also includes a plurality of user devices 105 and a service device 106. The service device 106 may include a point of sale machine, but may also include additional components that are integrated with the system 101 in order to provide goods and for services to the users 206 of the system 101. All components are connected through the network 108. In the illustrated embodiment, the network 108 comprises a local area network (LAN). Alternatively, the network 108 may also comprise alternate modes of digital communication, for example, an Internet link, an intranet, a WAN, dial-in-connections, cable modems, wireless modems, and/or ISDN lines. Alternate methods of communication between the above components are also available.

The system controller 102 is configured to execute all interactions between the functionality database 103, the user interface 104, and the analytics database 107. First, the system controller 102 handles inputs and outputs from the functionality database 103. This includes the managing of location elements (see below); the analysis and management of feature sets and actions between users (see below); and the generation and management of unique identifier used in conjunction with the location elements (see below). Second, the system controller 102 also manages all input and output from the various user devices 105 attached to the system 101 through the user interface 104. Third, the system controller 102 handles transaction data and history from the service device 106, as well as other service devices incorporated into the system. Fourth, the system controller analyzes data and output the analytics database 107.

The functionality database 103 handles the storage and organization for the majority of data types used by the system 101. These data types include location elements, feature sets, and unique identifier. The functionality database 103 may be directly coupled with the system controller 102 by way of a stand-alone server (not shown) or separately from the system controller 102, in communication through the network 108. In one embodiment, the location elements are digital records that contain instructions that are used to designate the dimensions of locations or areas within a particular space. These instructions are then utilized by the system 101 in order to determine if a particular user is currently within the particular area designated by one of the location elements and therefore able to access a particular feature set available within that area. The location elements may encompass an entire venue and therefore grant access to every user. Alternatively, the location element may be limited to a smaller committable area within a venue. Location elements may also be used in conjunction with unique identifiers in order to limit user access to particular area of a space. In one aspect, the location elements may be modified, generated and deleted from the functionality database 103 depending on the needs of the venue. Feature sets may include a single action or multiple actions that may be used by the various users 206 through their user devices 105 in order to interact with each other and the system 101. These actions may be divided into either user actions or system actions. User actions may include any form of communication that is available between users interacting with the system 101. These actions may include, but are not limited to, chatting, sending pictures, non-language gestures (e.g., virtual winks, hugs, kisses, etc.), and invitations to committable areas (more regarding invitations will be discussed below). These user actions may be dependent on the other data types held within the functionality database 103 (i.e., location elements and unique ids) and may not be available to all users in all instances of contact with the system. The relationship between the location elements, features sets, and unique ids will be discussed further below.

System actions are those actions that involve at least one user within the system 101 and may require an additional system component in order to complete the action. As a non-limiting example, a user may initiate a system action found within a feature set in order to make a purchase from the venue. Such an action may also utilize the service device 106 in order to register the transaction and verify the approval of the action. Such an action is further recorded within the functionality database 103 in order to maintain a record of the user's action within the venue. Additional system components may also be integrated into the system 101 in order to allow a user to initiate other types of system actions with a feature set. Some system actions may not require a service device 106 and only require the user to interact with the system 101 directly.

Finally, unique identifiers are generated and stored within the functionality database 103 and utilized in order to allow users to gain access to restriction locations within a space as designated by one or more location elements. Unique identifiers serve as digital keys that may be generated and distributed to users 206 within the system 101 in order to grant user access to a particular geographical space (i.e., a committable area) within a venue. Unique identifiers may be generated by particular system actions within a feature set. Unique identifiers may also be locked to a particular user or freely distributed within the system 101.

The user interface 104 is coupled to the system controller 102 and connects the system controller 102 to at least one of the user devices 105. The user interface 104 serves to manage the input from the user device 105 and forwards the input on to the system controller 102. The user interface 104 also receives the required location data from the user device 105 in order for the system controller 102 to determine a user's ability to access a particular feature set within the functionality database 103. The user interface 104 may be formed as a unified interface or as individual device interfaces depending on the implementation of the system. In one embodiment, the user interface 104 is an advanced programming interface: defined as a programmed communications link between a user device 105 and the system controller 102. The user interface 104 may also be implemented in hardware through the network 108, or some other suitable method.

The user device 105 grants a user access to the system 101 in order to interact with other users and with the venue. A user device 105 also grants an administrator access to the system 101 in order to make changes or view information generated by the system 101. The user device 105 communicates through either the user interface 104 or the admin interface 109, which then parses information directly to the system controller 102. As a non-limiting example, user device 105 is represented as a cellphone, an Apple® Iphone® and/or Android™ handset but may also be a non-smartphone-type cellphone, tablet, laptop, or another wireless device configured to integrate into the system 101.

The analytics database 107 is coupled to the system controller 102 and maintains statistical information used by the system 101 in order to monitor and analyze user behavior within the system. This behavior may include, but is not limited to, transaction history, user actions, system actions, and messaging history. Statistical models for any particular behavior type as well as triggers for certain behaviors may also be stored within the analytics database 107. The analytics database 107 may exist as a separate database within the system 101 or combined with the functionality database 103.

### Environment Generally

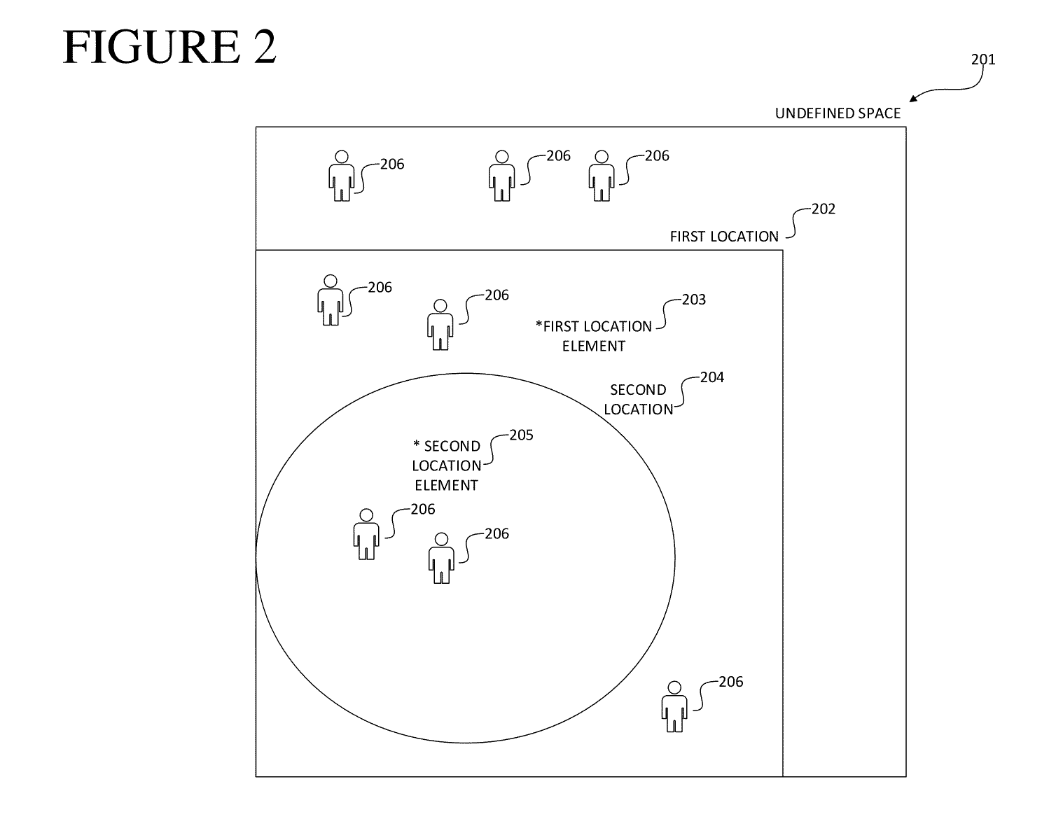

FIG. 2 is a perspective view of an exemplary environment 201 utilizing system 101. In order to understand the utility of the components within the system 101, this environment 201 will demonstrate a non-limiting environment that will utilize all elements and demonstrate their interactions with one another.

The environment 201 may represent any undefined venue prior to the implementation of the system 101. A venue in this context may be defined as nightclubs, bars, resorts, restaurants, cruise ships, lounges, stadiums, festivals, bowling alleys, malls, or similar entertainment or gathering places with definable geographic locations. Such venues may also include committable areas, which may involve VIP sections, private parties, promotional section, or any additional type of subsection with additional differentiating elements. Other similar, multi-use spaces may also implement the system 101 and allow for its use by users within the space. For example, in the illustrated embodiment the environment 201 may include the first location 202 and the second location 204. The first location 202 may be designated as the entire space occupied by the environment 201, but may also be designated as a smaller area within the environment 201. The second location 204 is designated as a smaller space within the first location 202. Traditional large nightclubs may have a general admission areas as well as committable areas within their venues (with the first location 202 and second location 204 meant as representations of these areas). This is not meant to be limiting as the second location 204 is not required to be within the first location 202. An administrator of the system 101 is able to set the geospatial dimensions of the locations 202, 204 in order to meet the needs of a particular venue.

Each location 202, 204 may be marked through the use of a location element generated and maintained within the functionality database 103. The first location element 203 may designate the dimensions of the first location 202 and the second location element 205 may designate the dimensions of the second location 204. Also, based on the dimensional information stored with the location elements 203, 205 the system 101 may determine whether or not a user 206 may access a feature set stored within the functionality database 103. The system 101, through the system controller 102, may determine if the user device 105 utilized by the user 206 is within the dimensions of the first or second locations 202, 204 through comparison of the location elements 203, 205 with the current GPS coordinates emitted by the user device 105. Other methods of geospatial identification for the user device 105 may also be used including wireless fidelity standard (Wi-Fi), cell phone triangulation, Bluetooth low-energy (LE) and/or any other suitable method.

Furthermore, the environment 201 may utilize a unique identifier within the functionality database 103 in order to limit a user 206 from accessing one location over another. Using FIG. 2 as an example, the system 101 may designate the requirement of a unique identifier for a user to enter the first location 202 of the environment 201. A user 206 may request a unique identifier through accessing an action within a feature set found within the functionality database 103. As an example, the user 206 may pay a cover fee through a user device 105 or “check-into” the venue through the user interface 104. Either action will grant the user 206 a unique identifier and allow the user 206 access to the first location 202. By accessing the first location 202, the user 206 then has access to additional feature sets and features within the functionality database. This is also true when the user 206 attempts to access the second location 204.

Additional venues may also establish a system 101 and designate locations and feature sets as well. Users 206 may then migrate from one venue to another, altering their available feature sets based on their location.

The relationship between the feature sets, the location elements, and the unique identifiers within the functionality database 103 will be further explained within the additional concepts outlined below.

### Social Migration

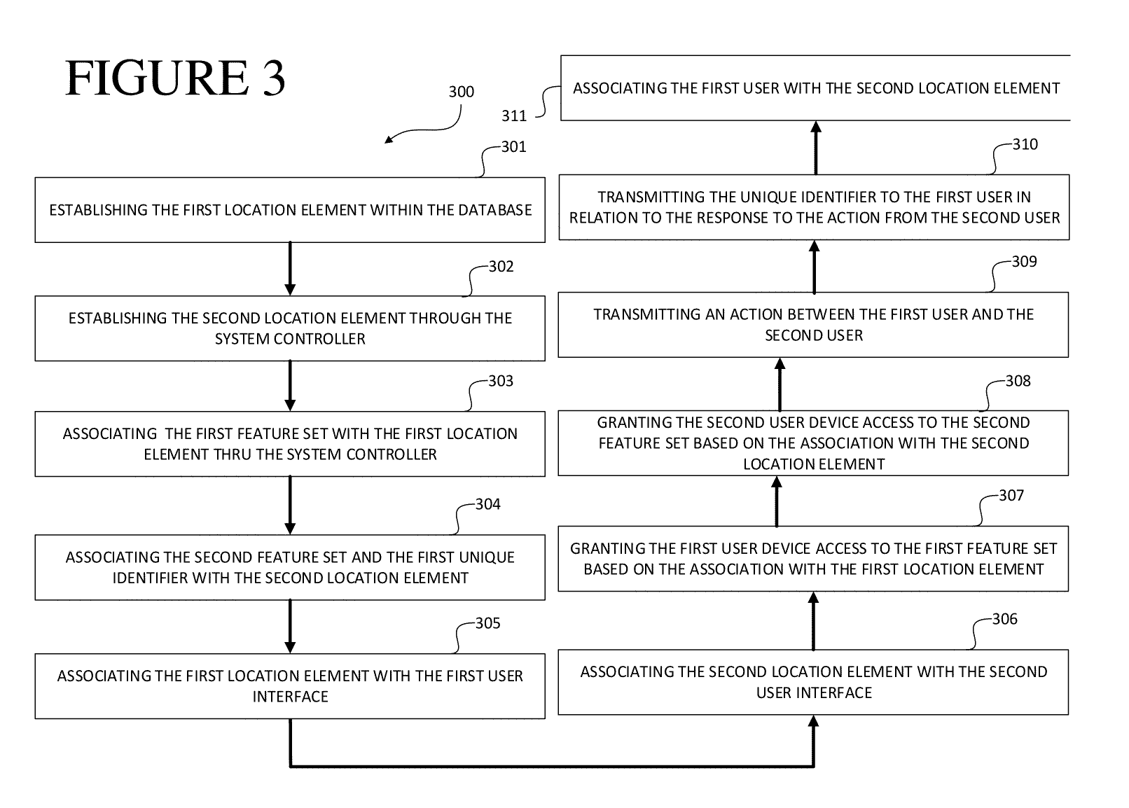

FIG. 3 is a flowchart of an exemplary representation of a method for generating location-based communication and interaction features that is executable via system 101. The method begins with step 301, with the system 101 establishing the first location element 203 through the system controller 102. This generates an element within the system 101 that can be utilized by the system to associate with particular spatial dimensions found within the environment 201.

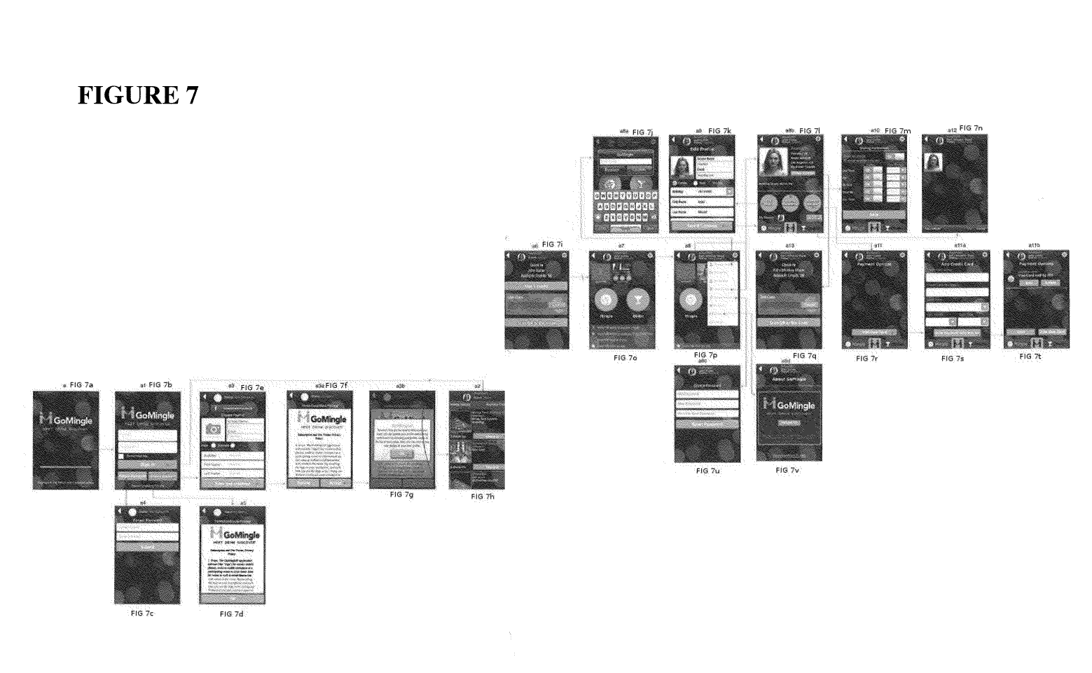

Next, at step 302, the system 101 establishes the second location element 205 through the system controller 102. This establishes two separate areas within the environment 201 in order to establish different feature sets and allow users 206 within the system 101 to provide their geographic locations to one another. At step 303, the system 101 associates a feature set 103b within the functionality database 103 with the first location element 203. This allows for general functionality of those features to the user that are geographically present within that location, as indicated by their association with the first location element 203. For example, an administrator may establish a basic initial feature set and attach that feature set to an initial location element encompassing their entire venue. This would grant all users within the venue access to that feature set upon associating themselves to the location within the system 101 (e.g., through proximity, checking-in, etc.). FIGS. 7g and 7h show an illustrative example of how a user could access an initial location through a check-in and utilize the feature set established for that venue.

Next, at step 304, the system 101 associates the second feature set with the second location element 205 and a first unique identifier. The first unique identifier acts as a key in order to grant a user access to the second location 204 within the venue. Next, at step 305, the system 101 associates the first location element 203 with the first user interface 104. This allows for the system 101 to begin interacting with any users that begin accessing the system 101. In particular, both associations allow for the venue 201 to begin allowing communications between users 206 and to grant system-based features.

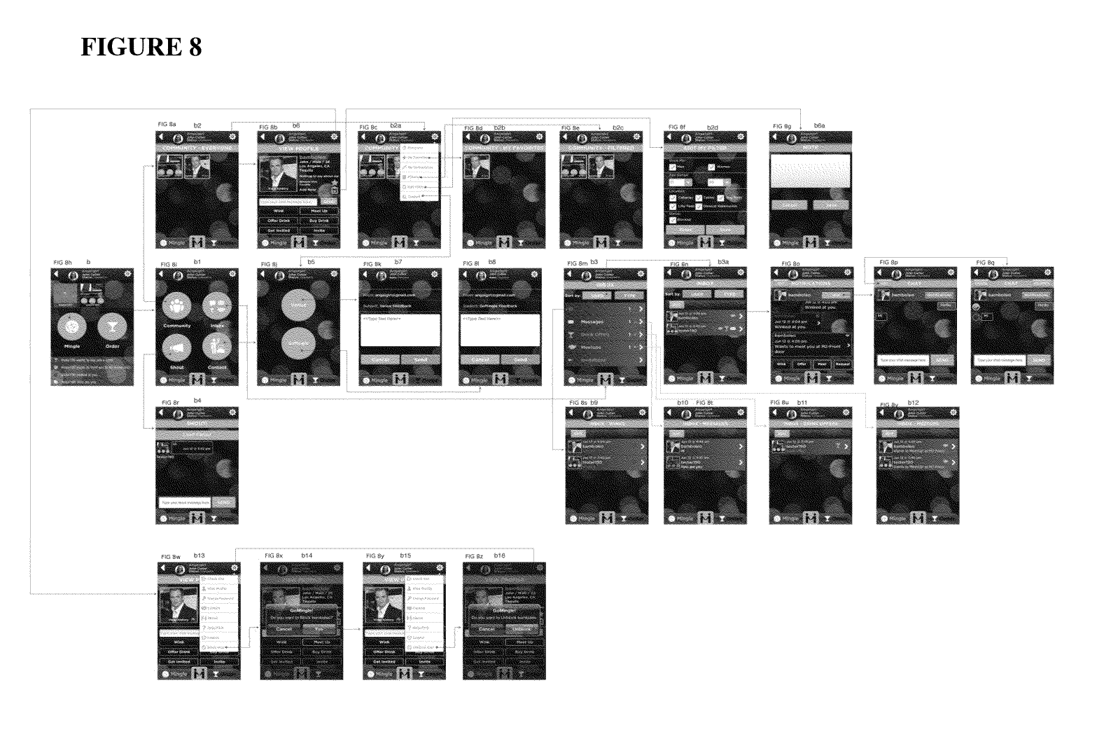

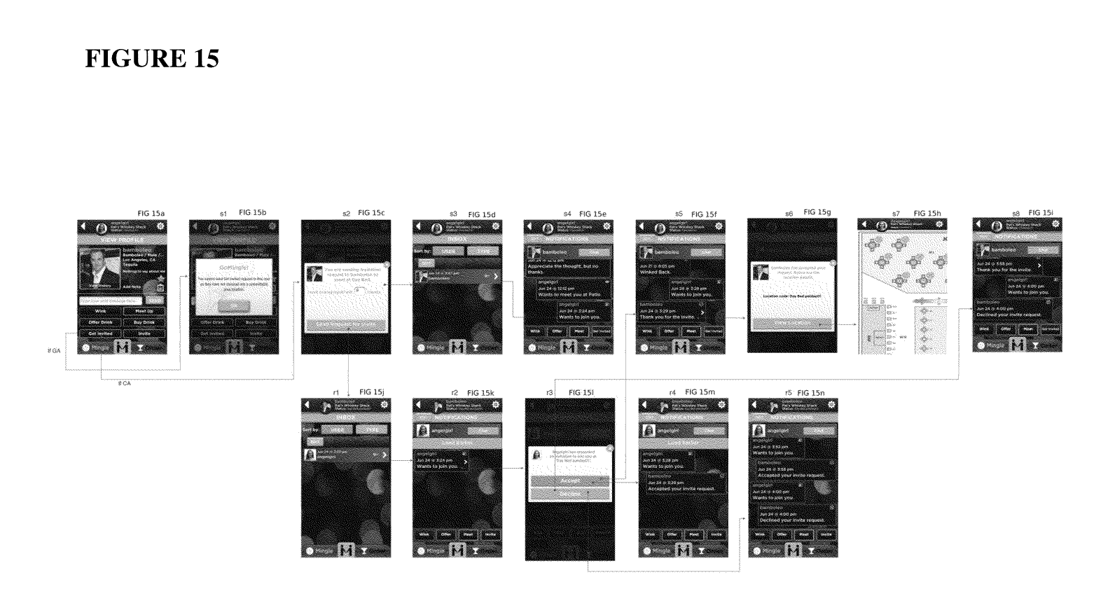

The method then proceeds to step 306, where the system 101 associates the second location element 205 with the second user interface. Next, at step 307, the first user now has access to the first feature set 103b coupled to the first location 202 within the venue. FIG. 8b is an illustrative example of a user's profile screen with the initial feature set activated as a result of their current location within the venue. Now the first user has access to any of the actions contained within the feature set. This includes all the actions represented within FIG. 8b, for example Wink, Offer Drink, Get Invited, Meet Up, Buy Drink, and Invite. The system 101 is not limited to these actions and as such additional actions may be available to a user depending on the set up of the system 101 by an administrator. Next, at step 308, the second user associated with the second user interface has access to the second feature set associated with the second location element 205. Next, at step 308, either the first or second user may initiate a particular action within either the first or second feature set in order to gain or grant access to the second location 204 within the venue. The particular action within step 309 may be an invitation to the second location or the purchase of a “table” within the second location through the system 101. An invitation action would occur from the second user to the first user. This is due to the second user having access to the “invite” action and access to the first unique identifier through the second feature set. Alternatively, the first user may initiate a “get invited” action through the first feature set in order to gain access to the second location. Then, at step 310, upon confirmation of either of these actions by the system controller 102, the system controller 102 will associate the first user device a unique identifier associated with the second location 204. It is with this unique identifier that the user may gain access to the second area 204. While the system digitally manages the unique identifier for the sake of crowd control within a venue, these identifiers may be shown in many ways to the users. FIG. 15g is an example of a unique identifier presented to a user. Here, it takes the form of a simple code. Other examples of representations to users may include bar codes, QR codes, or approvals for access through non visual technologies (i.e., near-field communication). Finally, at step 311, the system 101 finalizes the process by granting the user 206 access to the second location element within the functionality database 103 through the unique identifier.

In another embodiment of the present invention, the method includes a step allowing an administrator to make modifications to the first and second location elements. These modifications may either be tied to the physical dimensions of the spaces or tied to the associations of the location elements themselves. For example, modifications to the dimensions of a space would allow an administrator to “re-draw” a venue in order to meet the particular requirement of an event. Other modifications may correlate the number of users actively using the system 101 (i.e., by tracking the number of associations between the location elements and the user interfaces) in order to grant options to an administrator. Furthermore, each modification could also be tied to the number of unique identifiers associated with either the first or second location elements. This type of modification would allow for an administrator to tailor other elements within the functionality database 103 (feature sets, location elements, etc.) based on the current number of unique identifiers currently active with the system 101.

In another embodiment of the present invention, the method includes a step of allowing an administrator to perform any of the following modifications to the components of the functionality database 103, including: removing either the first or second location elements; adding a third location element; modifying either the first or second feature sets; removing a feature set; adding a third feature set; removing either the first or second unique identifier; adding a third unique identifier. This will allow for an administrator to modify all aspects of the functionality database 103 in order to better suit the environment 201 that is utilizing the system 101 and the particular needs of the users 206 currently active within the system 101.

Furthermore, in another aspect of the present invention, each feature set further includes a plurality of features and further includes the step of allowing an administrator to modify the number of features from the first or second feature sets. Like all the components described above, an administrator may also wish to add or remove particular features in order to tailor the experience of a user 206 within an environment 201. Each feature may contain an additional method of communication (text, audio/video, or gestural like a wink) that may be used by the user with access to that particular feature set. Each feature may also contain a particular transaction that may be utilized by a user through their user device associated with a venue or committable area. For example, the purchase of access into a committable area or particular food or drink items may also be limited to particular area of the environment 201. These features serve only as examples and are not meant to limit an administrator ability to customize the interaction between the users 206 and the system 101.

In another embodiment of the present invention, the method further includes a second unique identifier and a second user interface. The method further includes the steps of: coupling a second user device to the system controller and allowing the user of the first user device to associate the second location element to a second user through associating the second unique identifier to the second user device; and granting a user of the second user device access to the second feature set and the second location element based on the association with the second unique identifier. These method steps allow for an initial user 206 to grant access to a second user 206 to a particular location within the environment 201 (either the first location 202 or the second location 204) by through transmitting the second unique identifier to the second user device. The first user may trigger the transmission of the second unique identifier through initiating a prior action with a feature set (such as an invitation). FIGS. 15a through 15u are representative screenshots showing an invitation request that would trigger the transmission of the second unique identifier. The system 101 will detect this prior action in order for the system controller 102 to transmit the unique identifier. This prior action may be pre-established within the functionality database 103 or modified by an administrator. Also, the number of unique identifiers available for transmission by the first user may also be limited within the functionality database 103. This limitation may be predetermined within the functionality database of vary based on metrics associated with the first user within either the functionality database 103 or the analytics database 107.

### Progressive Socialization

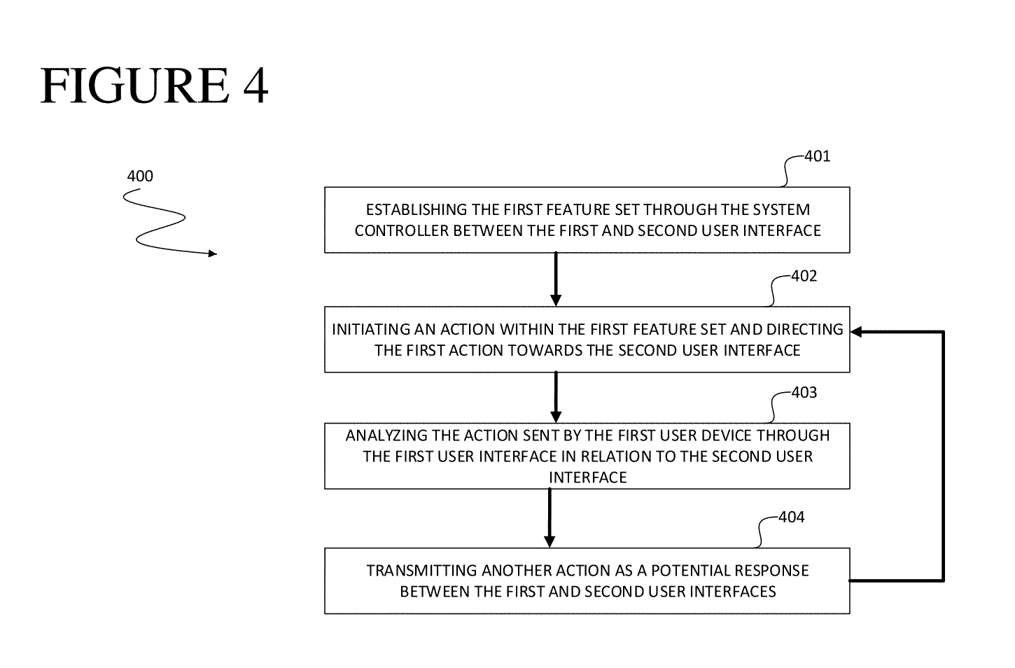

FIG. 4 is a flowchart of an exemplary representation of a method for recommending communication actions within a relationship-based system that is executable via system 101. The method begins with step 401; with establishing the first feature set through the system controller 102 between the first and second user interfaces 104.

Next, at step 402, the system controller 102 detects the initiation of a first action within the first feature set by the first user and directs the first action towards the second user interface. This first action may be any of the initial actions found within FIG. 8b, for example Wink, Offer Drink, Get Invited, Meet Up, Buy Drink, and Invite along with any of the additional input required by a particular action.

At step 403, the system 101 analyzes the first action initiated by the first user. The system 101 establishes a hierarchy amongst the actions that are present within a feature set. As such, when a first user chooses an action, the system 101 will determine if there are additional “higher” actions available. For example, winks may be deemed lowest while invites are deemed highest. This hierarchy can be predetermined by the administrator of the system 101 or dynamic, allowing for changes to the hierarchy according the actions of the users throughout the system 101. The system 101 maintains a predetermined hierarchy by default. Finally, at step 404, the system provides another action as a potential (or recommended) response by the second user through the second user device. Based on the analysis of the first action conducted by the system controller 102, the system 101 will attempt to recommend a higher action in order to “progress” the socialization between the users. For example, a wink or a message may lead the system to recommend offering a drink or meet up, a drink offer may lead to an invite into a second location (a committable area), etc. As stated above, the actions, e.g., potential responses and interactions, are arranged in the progressive structure or hierarchy. Each user's interactions with other users may be categorized and/or displayed as a function of the progressive structure. In other words, the responses or other users may be displayed based on the category which is indicative of a location on the hierarchy. This allows the user to view, prioritize and make a decision regarding their next planned interaction.

In another embodiment of the present invention, the method is iterative and will continue through successive actions between the users in order to escalate the socialization between them into higher ranked forms of communication as established within the system 101. Thus, the method 400, the system will return to step 402 upon providing a responsive action at step 404.

In another embodiment of the present invention, users will also have the ability to block successive potential responses in order to end communications from another user. This will provide a security mechanism for the users that are active within the system 101 and ensure that unnecessary communications do not tie up system resources established within the environment 201.

In another embodiment of the present invention, the escalating process may be forced upon the users that initiate communications with each other by blocking actions as they are used between both users. For example, winks may no longer be available once text messages are initiated, or drink offers may cease once a meet up request is accepted between users. Likewise, the system 101 may keep all communication methods available while still recommending successive potential responses.

In another embodiment of the present invention, the method further includes a first location element 203 and a second location element 205, a feature set including a third action, and first unique identifier. The method further includes the steps of: establishing the first location element 203 with a first physical location 202 through the system controller 102; establishing the second location element 205 with a second physical location 204 through the system controller 102; associating the first feature set with the first location element 203; associating the second feature set with the second location element 205 and the first unique identifier; associating the first location element 203 with the first user interface 104; coupling the first user device 105 with the system controller 102 through the first user interface 104, where the user device 105 is associated with one of the first and second location elements and the system controller 102 allows a user of the first user device 105 to access to the first feature set if the first user device 105 is associated with the first location element 203 and allows the user to initiate an action within the first feature set that associates the first unique identifier to the user; granting the user of the first user device 105 access to the second feature set and the second location element 205 based on the association with the first unique identifier; analyzing the association of the first user device to the first unique identifier; and providing the third action as a potential response by the first user to the second user through the second user device via the second user interface.

In another embodiment of the present invention, the method further includes the steps allowing the first user or second user to perform the following actions: sending a text message to the second user; initiating a financial transaction; sending a predetermined text message to the second user; sending a predetermined audio/video/image file to the second user; sending a set of geographic instructions to the second user; and sending a request to the second user requiring a response.

### Social Intelligence

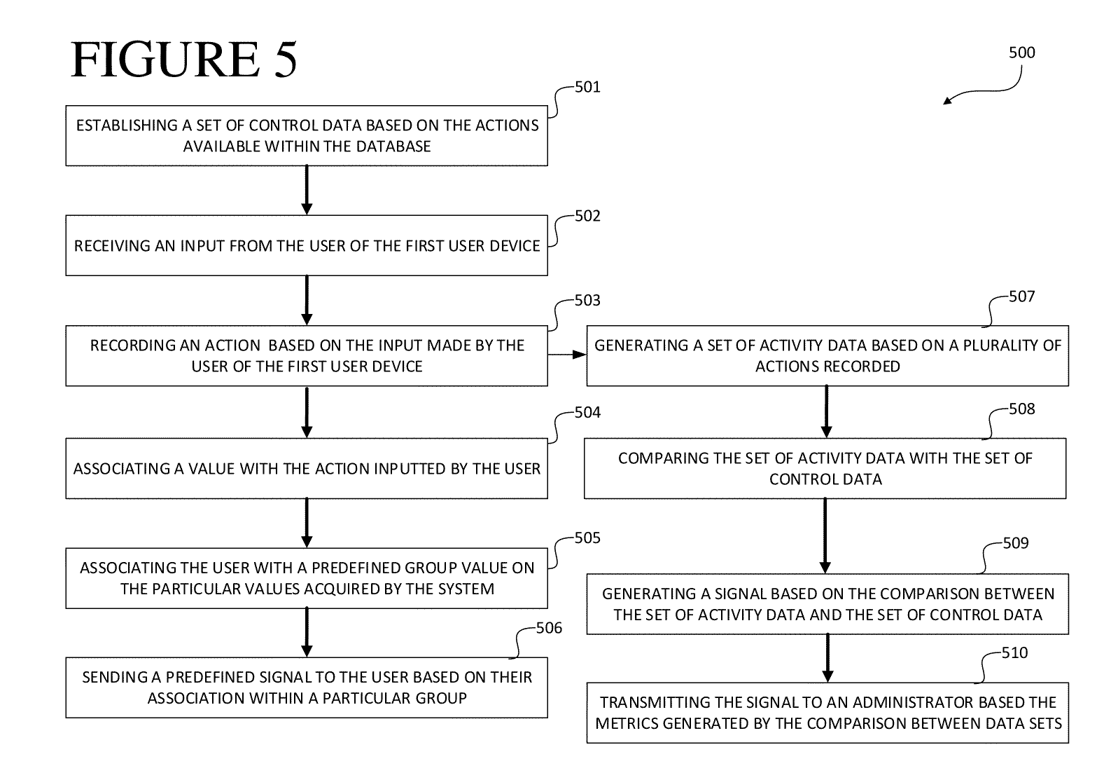

FIG. 5 is a flowchart of an exemplary representation of a method for generating user metrics based on social data that is executable via system 101. The method begins with step 501, where the system 101 allows an administrator the ability to establish a set of control data based on the actions available within the functionality database 103. This set of control data can be established either through a series of total social interactions and can also include the total purchasing transactions that are possible by a user interacting with the system 101. The set of control data can be predetermined by an administrator or dynamically created based by the system 101. The system 101 may also allow the administrator to establish the metrics to be generated as a function of the user and transaction data and to establish a set of signals to be generated as a function of defined deviations from the metrics. Next, at step 502, the user interface 104 receives an input from the first user device 105. This input may account for any possible action taken by the user that is of interest to the system. Primarily, such input could be the initiation of an action with the first feature set associated with the user at the venue, but additional metrics accounted for by the system 101 could also be received as inputs by the user interface 104. Regardless of the input by the user, the system 101 will generate an action through the system controller 102 of the input from the first user device 105 at step 502.

Next, at step 503, the system records an action based on the input made by the user 206. At this point there are two different embodiments that provide varying steps for the remainder of this invention. Within the first embodiment, the method continues through step 504, where the system controller 102 associates a value with the action/input initiated by the user 206. This value is predetermined by the administrator and can either reside within the functionality database 103 or the analytics database 107. This value is used by the system in order to generate a numeric total value to the actions initiated by the user. Based on this value generated by the user, the system 101 at step 505 associates a user 206 with a predefined group value based on the particular total values within the system 101. These value totals are stored either within the functionality database 103 or the analytics database 107 and are used in order to determine a particular “loyalty” or user level within the system 101. Finally, at step 506, the system sends a predetermined signal to the user based on their association within the particular group. This signal can take many forms, including drink offers and other special advertisement prearranged within the system 101 and associated with the particular value group associated with the user 206.

Within a second embodiment of the invention, the system 101 will generate a set of activity data based on all the actions initiated by a user at step 507. This set of activity data will group particular actions together and also associate them based on their time, location, and additional metrics as predefined within the system 101. Next, at step 508, the system 101 will compare the set of activity data with a set of control data stored within the system. The set of control data may either be within the functionality data 103 or within the analytics database 107. This set control data will be predefined within the system in order to develop a comparison with the set of activity data generated by the user.

Next, at step 509, the system 101 will general a signal based on the statistical results between the set of activity data and the set of control data. These statistical results may include average and deviations from norms established within the set of control data for a particular action. Such a signal may be in the form of a warning message to an administrator of the system 101 regarding a particular user. Finally, at step 510, the system 101 will transmit the generated signal based on the comparison between the activity data and the control data.

In another embodiment of the present invention, the plurality of actions each includes purchase actions initiated by the user.

In another embodiment of the present invention, the plurality of action each includes interactive actions initiated by the user.

In another embodiment of the present invention, the activity data includes the total sums of purchase actions initiated by a particular user.

In another embodiment of the present invention, the statistical results include an average difference between the set of activity data and the set of control data.

In another embodiment of the present invention, the activity data includes the median purchase amount by a particular user.

In another embodiment of the present invention, each action received by the user is coupled with an interactive response and comprises a complete communication within the database.

In another embodiment of the present invention, the activity data includes the total sum of interactive actions initiated by a particular user.

In another embodiment of the present invention, the statistical results include a deviation between the set of activity data and the set of control data.

In another embodiment of the present invention, the activity data includes the total sum of completed communications associated with a particular user.

In another embodiment of the present invention, the statistical results include a deviation between the set of activity data and the set of control data.

In another embodiment of the present invention, the system controller 102 is configured to store the signal within the database 103. The system controller 102 may also be configured to store the signal within the analytics database 107.

In another embodiment of the present invention, the system controller 102 is configured to send the signal to an administrator. This may be by way of the user interface 104 or through another device connected to the system controller 102 (i.e., the point of sale device 106).

### Micro Social Environments

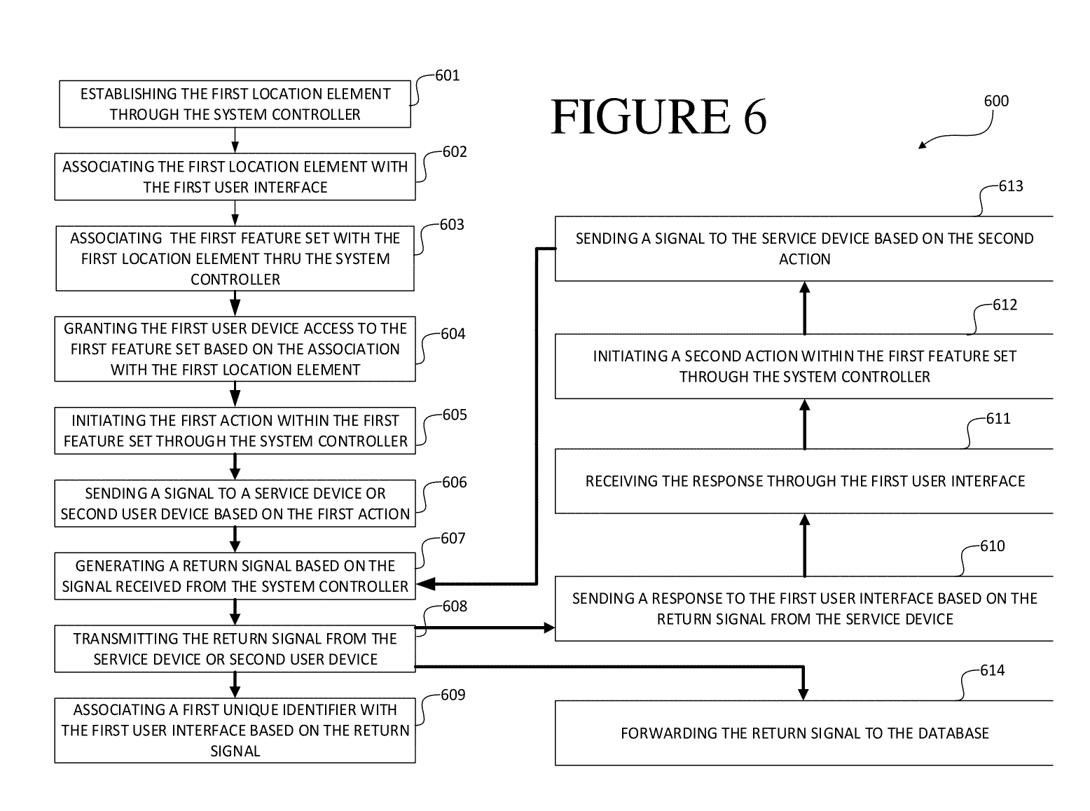

FIG. 6 is a flowchart of an exemplary representation of a method for generating micro-social environments that is executable via system 101. The method begins with step 601 by establishing the first location element 203 through the system controller 102. Next, at step 602, the system 101 associates the first location element 203 within the first user interface 104. Next, at step 603, the system controller 102 associates a first feature set within the functionality database 103 with the first location element 203. This ensures that all features within the first feature set are accessible to users associated with the first location element 203. Next, at step 604, the system 101 grants the first user device 105 access to the first feature set based on the association of the first user device with the first location element 203. Now as a result of this association, a user can access features and actions within the feature set while they remain associated with the first location element 203.

At this point the user 206, through the first user device 105, will trigger varying steps within the method 600 depending on the type of action initiated within the system 101 at step 605.

In one embodiment of the present invention, at step 606 the system 101 sends a signal to a service device 106 or a second user device 105 based on the initial action by the user 206. At step 607, the service device generates a return signal based on the signal received from the system controller. This return signal is based on both the action initiated by the user 206 and the predetermined return signal established within the system controller 102. Next, at step 608, the system 101 transmits the return signal from either a service device 106 or a second user device 105 back to the first user device 105.

In another embodiment, the system associates an additional element within the system 101 based on the return signal at step 609. As a non-limiting example, the system can associate a first unique identifier (stored within the functionality database 103). This can occur when a user requests access to the second location element 206 and completes the necessary actions in order to receive the unique identifier.

In another embodiment, the method 600 can provide an iterative process for processing return signals into interactive responses by way of the service device 106 through steps 610 through 614. This series of steps may be utilized in the event that an action initiated by the user 206 requires confirmation or completion of a transaction through the service device 106. A non-limiting example includes the interaction between a user 206 and the system 101 during a confirmation of a credit card transaction. The system will send a return signal with either the confirmation or a rejection of the transaction depending on the information provided by the user 206.

Within another embodiment of the present invention, the system 101 will also forward the return signal to either the functionality database 103 or the analytics database 107.

### Industrial Application

FIGS. 7 through 23 show an embodiment of the concepts described above (Social Migration, Progressive Socialization, Social Intelligence, and Micro Social Environments). This embodiment is in the form of a social application platform designed for use on smart phones (i.e., Apple® Iphone®/Android™/Windows® phone devices). This social application allows for various user interactions based on the use of the system 101, along with an environment 201, in order to implement the concepts described in the prior sections. Each figure shows the flow through a particular module present within the application platform. Each module utilizes elements of the system 101 in order to implement one or more of the methods described above.

FIG. 7 is a diagram flowchart of the account and venue module built into this embodiment of the present invention. FIG. 7a through FIG. 7f show the application's initial log in process. FIG. 7a is an initial splash screen that occurs while the application is loading. Next, the application guides a user 206 through the log-in process. Should the user not have initial log-in credentials, the application will request that the user register (either through the application's own member services or with another set of social media credentials) and create a user profile. The registration process will ask that the user add a plurality of user metrics that will allow the application to best generate search filters and venue-related information for the user. Regardless of whether or not a user has prior credentials, the application will display terms of service and use that will require confirmation by the user in order to gain access to the application.

FIG. 7h is a listing of the venues that are available to the user once they are logged into the system. The application arranges the venues in order of the proximity to user, with the closest venues at the top of the list. In order to utilize any features within the venue, the user may have to check-in. FIG. 7i will ask the user to use credits built into the application or scan a QR/barcode in order gain access to the venues features. Such credits may be purchased through a credit card transaction or transferred between users in the system. Also noted within FIG. 7i is the instance of the “gear” icon in the upper left hand corner of the screen. On each app screen, the gear icon is at the top right will allow the user to navigate to general application (i.e., check-out of venue, display the location map) or screen-specific (i.e., edit filter criteria during a search) app functionalities. Each screen's gear functions are dependent on the screen's intent as detailed below within the remaining figures.

FIG. 7o shows the initial check-in landing page seen by user upon check-in to a venue. The top bar has access to a user's profile and the options screen. The central band of icons will forward venue specific information as well as venue specific communications (such as chat messages from users in that venue). Main access to all features within the application is divided between ‘Mingle’ button and the ‘Order’ button. Below the ‘Mingle’ button and the ‘Order’ button is an interactive ‘recents’ list of actions between the user and others within the venue. These recent actions update in real-time in order to keep the user aware of communications within the application. Both the ‘Mingle’ and ‘Order’ button will be explained in later modules.

FIG. 7p shows the options pop-up menu that is accessible from the landing screen. The application presents a plurality of options including: change code, check out, venue map, view profile, change password, contact, about, and logout. ‘Change code’ will pull up a prompt asking for an alternate venue code, along with an additional confirmation by the user. This screen will allow for a user to change features within the venue through use of a different check-in code. This feature depends on whether the venue is utilizing multiple check-in codes at that venue or on that particular night. The ‘Check out’ option will allow a user to digitally “leave” a venue in order to access the feature set of another nearby property or in the event of the user changing venues. ‘Change password’ will allow user to change their access credentials for safety reasons. ‘Contact’ will allow a user to send a message to either the venue or the application developer (this option will be explained in further detail later). ‘About’ will display additional information from the developer. Finally, the ‘Logout’ option will allow a user to logout of the application completely.

FIGS. 7k through 7n all show the submenus within the ‘view profile’ option of the pop up menu. Here a user may edit their profile information, change/add/delete their credit card information, or changing their sharing options. Sharing options pertain to the particular elements of their profile that they wish to share with the other users in the application.

FIG. 8 is a diagram flowchart of the socialize module built into the embodiment of the present invention. The module begins with FIG. 8i, where the application presents the ‘Mingle’ landing page. This landing page still maintains the profile access and options bar above and now adds four option buttons (Community, Shout, Inbox, and Contact). There are also ‘Mingle’ and ‘Order’ tabs at the bottom of the screen. These bottom tabs will grand access to the two key divisions of the application and will appear on most figures and modules moving forward. In the illustrated embodiment, at the top of the landing page is a public news stream and at the bottom of the landing page is a personal news stream. The same public news stream is sent to the user device for all users and may include, for example and without limitation, new users check-in, shouts are posted, marketing posts, and similar general, public posts. In the illustrated embodiment, the private news stream may include only social actions received from another user. Selecting any item within one of the news streams will direct the user to a related feature set landing page or a user's page.

FIG. 8a is the Community main screen within the application. Here, users will see a grid showing all other active users within their particular venue. The Community grid is sorted based on proximity between the users by default. Additional options (FIG. 8c through 8f) allow for filtering the grid based on a user's preferences. Clicking on a particular user will bring up FIG. 8b, or a profile page for a user. Each profile page shows a picture along with the user's public information. A message bar is also available along with the six main actions available to a user (Wink, Meet Up, Offer Drink, Buy Drink, Get Invited, Invite). Furthermore, when a user is viewing another profile, they have the option of blocking the user within the options menu in the top right corner. This removes the user from their grid and blocks any further communications between the users. Each of these main actions will be explained within their own modules later on.

FIG. 8r is the Shout main screen within the application. Here, users may add messages to a common chat screen that is associated with the particular venue. This common chat screen is viewable by every user that is currently checked-into the venue. This screen maintains a message window below and the ability to load earlier messages above the main window.

FIG. 8j is the Contact main screen within the application. Here, users may send messages to either the venue or the application developer based on their experiences with the application. The application then routes the comments via email.

FIG. 8m is the Inbox main within the application. Here, users may access all the various types of actions that they receive from other users in the venue. These actions may be sorted by action type (FIG. 8m) or by user (FIG. 8n). Clicking through each action grants the user the ability to respond in the same way or with any of the additional actions provided by the application.

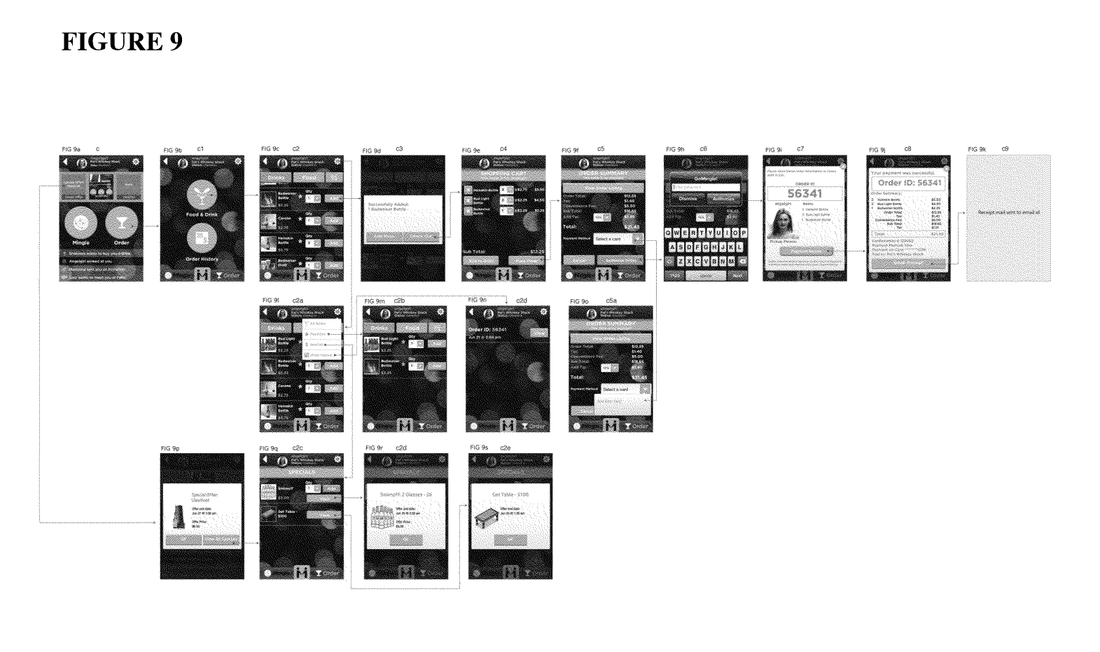

FIG. 9 is a diagram flowchart of the order module built into the embodiment of the present invention. FIG. 9a again shows the main landing page presented by the application. By selecting the ‘Order’ button on the landing page, a user reaches the ‘Order’ landing page (FIG. 9b) to begin the order process. A user may also select any of the specials available on the top bar of the main landing page. Any of these specials will produce a pop-up with the information related to that particular special. FIGS. 9p thru 9s show example specials that may be displayed within the application.

FIG. 9b has two main buttons (Food & Drink/Order History). The ‘Order History’ (FIG. 9n) will show a user all of their order activity associated with a particular venue. Each transaction is sorted by an Order ID number along with the date and time stamp.

FIG. 9c thru 9j will guide a user through the order process in order to purchase an item at a venue through the application. The main selection screen (FIG. 9c) presents all food and beverage item along with a quantity counter and an ‘add’ button. Adding each item will produce a pop-up screen (FIG. 9d) and a request for check-out. Once a user presses the check-out button they move on to the shopping cart (FIG. 9e) showing their entire order. Confirming the order moves the user to the order summary screen (FIG. 9h) where they may add gratuity and modify their payment options (i.e., choose from one of multiple credit cards stored within the application. The application will then request the user password (FIG. 9h) and once approved will provide a pop up screen with their order id and information (FIG. 9i). Additional Payment details are also available to the user (FIG. 9j).

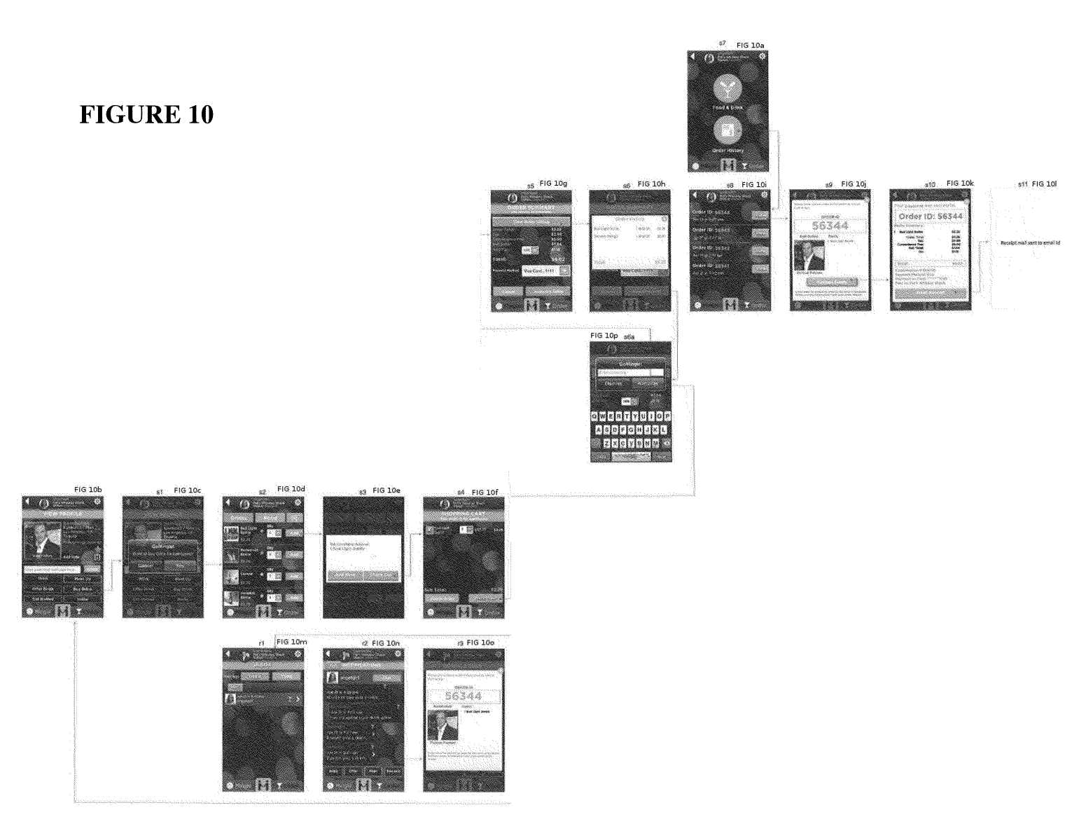

FIGS. 10/11 are diagram flowcharts of the buy drink and offer drink features built into the embodiment of the present invention. Both posses a similar user interface flow and thus will be explained together. Please note that this does not mean that these modules are functionally the same, but only that in this particular industrial embodiment they are able to share a similar user interface flow.

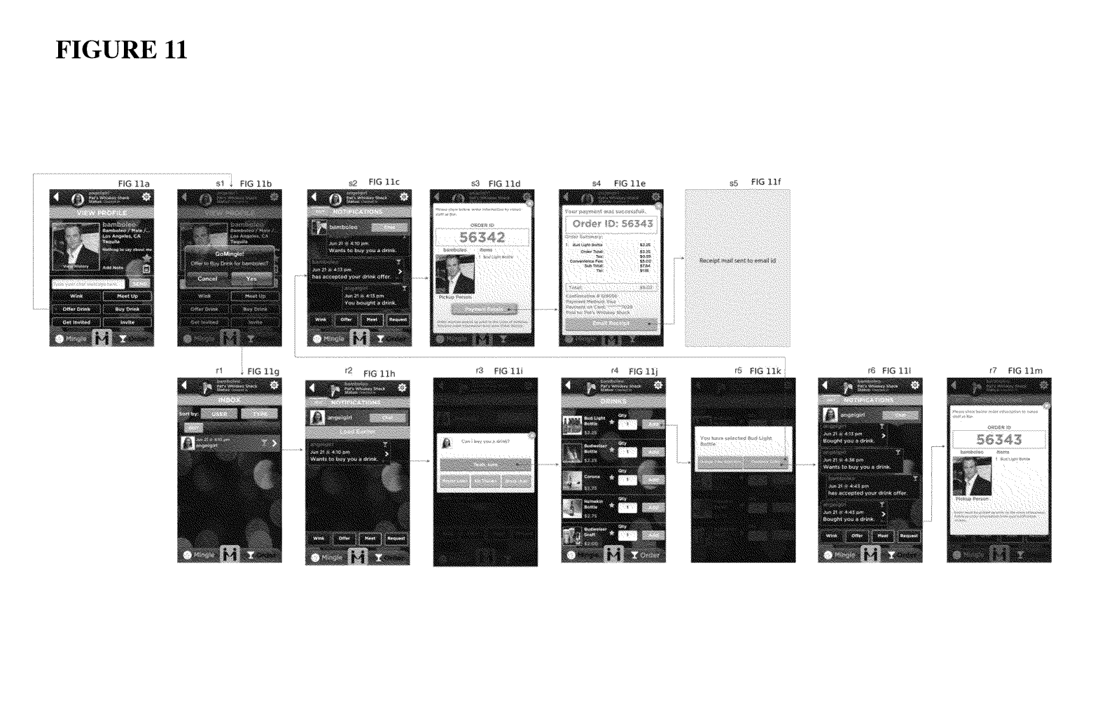

Both modules begin by selecting either the ‘Buy Drink’ or ‘Offer Drink’ option within a user's profile page (FIG. 10b/FIG. 11a). These actions may also be available through other action screens throughout the application.

At this point the ‘Buy Drink’ module guides the user through the order process to select a drink for another user (FIGS. 10d thru 10h, 10p). Within the ‘Offer Drink’ module, a recipient user received the offer for a drink through their inbox (FIG. 11g) and confirms the offer through a pop-up window (FIG. 11i). Following their confirmation, the recipient may then go through the order process (FIGS. 11j thru 11m) to complete their selection.

Once completed, both parties receive copies of the Order ID for their records (FIG. 10j/FIG. 10o/FIG. 11d/FIG. 11m).

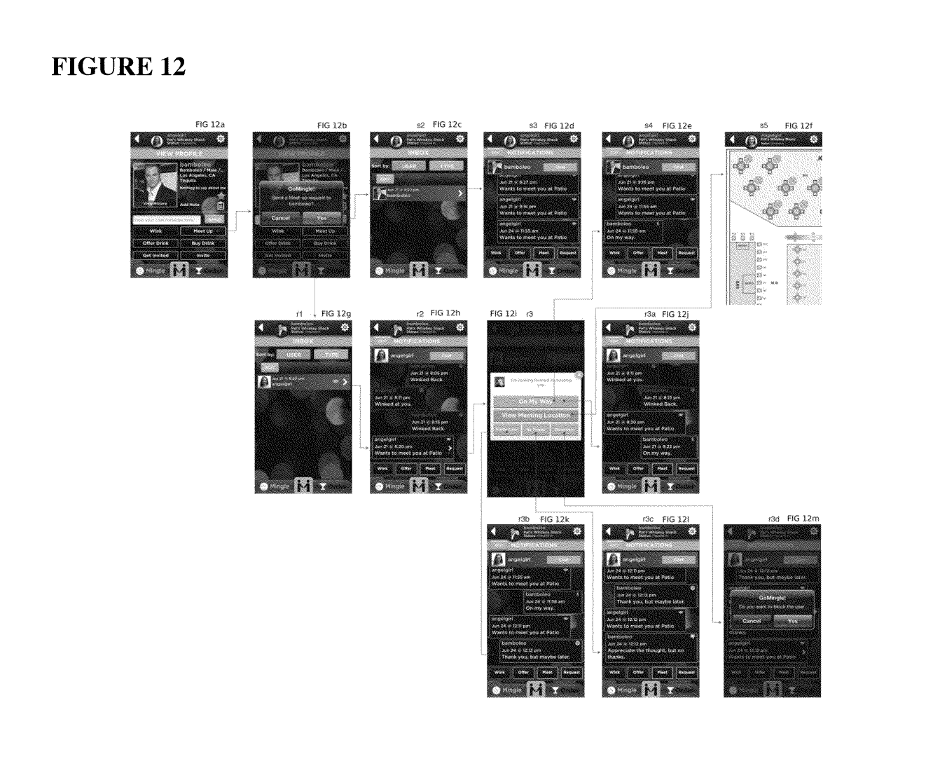

FIG. 12 is a diagram flowchart of the ‘Meet Up’ module built into the embodiment of the present invention. This module begins by selecting either the ‘Meet Up’ option within a user's profile page (FIG. 12a). This action may also be available through other action screens throughout the application.

FIG. 12b shows the pop up dialog confirming that the user wishes to send the meet up request to the recipient. Once confirmed, the recipient will receive the action within their inbox (FIG. 12g/FIG. 12h). When the recipient clicks on the notification, a pop up window will appear with their available response options (FIG. 12i). Those options are: On my way, View meeting location, Maybe later, No Thanks, and Block User.

FIG. 12d shows the response message sent to the user when the recipient clicks on the ‘On my way’ option.

FIG. 12f shows a representative map of the venue that is viewable by the recipient when they select the ‘View meeting Location’ option.

FIG. 12l shows the response message sent to the user when the recipient clicks on the ‘No Thanks’ option.

Finally, FIG. 12m presents a pop-up window and guides the recipient through the process of blocking the user sending the request.

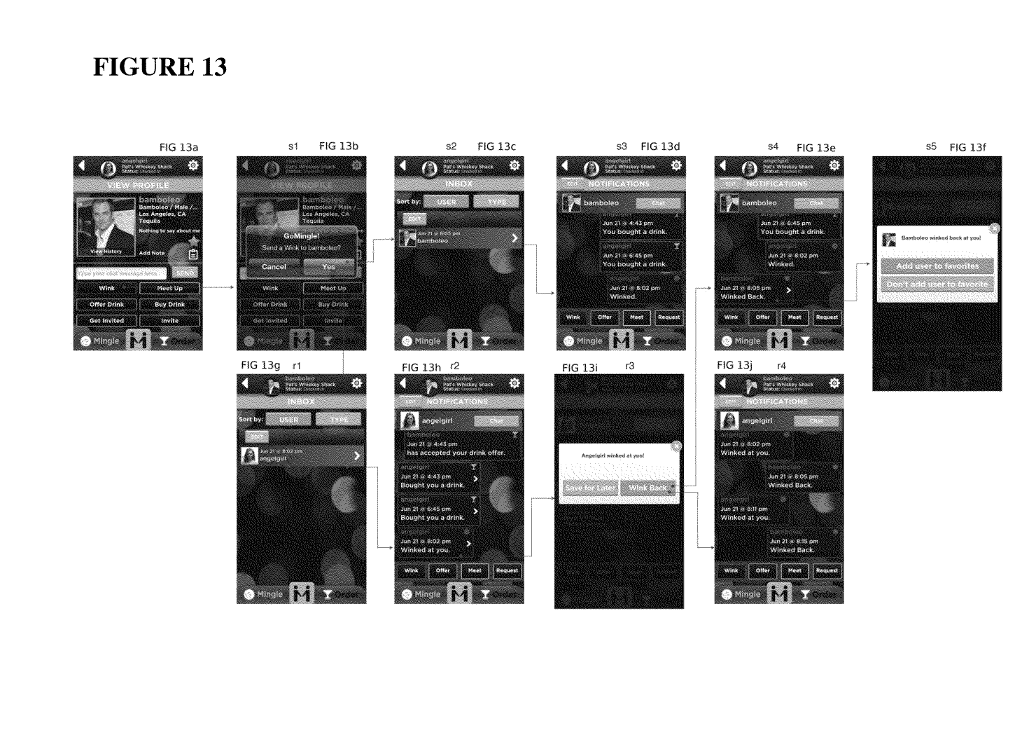

FIG. 13 is a diagram flowchart of the ‘Wink’ module built into the embodiment of the present invention. This module begins by selecting the ‘Wink’ option within a user's profile page (FIG. 13a). This action may also be available through other action screens throughout the application.

FIG. 13b shows the pop up dialog confirming that the user wishes to send the wink to the recipient. Once confirmed, the recipient will receive the action within their inbox (FIG. 13g/FIG. 13h). The user will receive confirmation of their wink through their notification screen as well (FIG. 13d).

When the recipient sees the wink in their inbox they may select in order to bring up more options. At that point a pop-up window will appear (FIG. 13i) granting the receipt additional options for a response to the wink (Save for later/Wink Back).

Save for later will not produce any response and allow the recipient to bring up the pop-up window again at a later time. The ‘Wink Back’ option will send a response to the user (FIG. 13e). The user may then select the ‘Wink Back’ response and see a pop-up window (FIG. 13f) with additional options (Add User to Favorites/Don't Add User to Favorites). These favorite options will add the user to the favorites filter within the user grid.

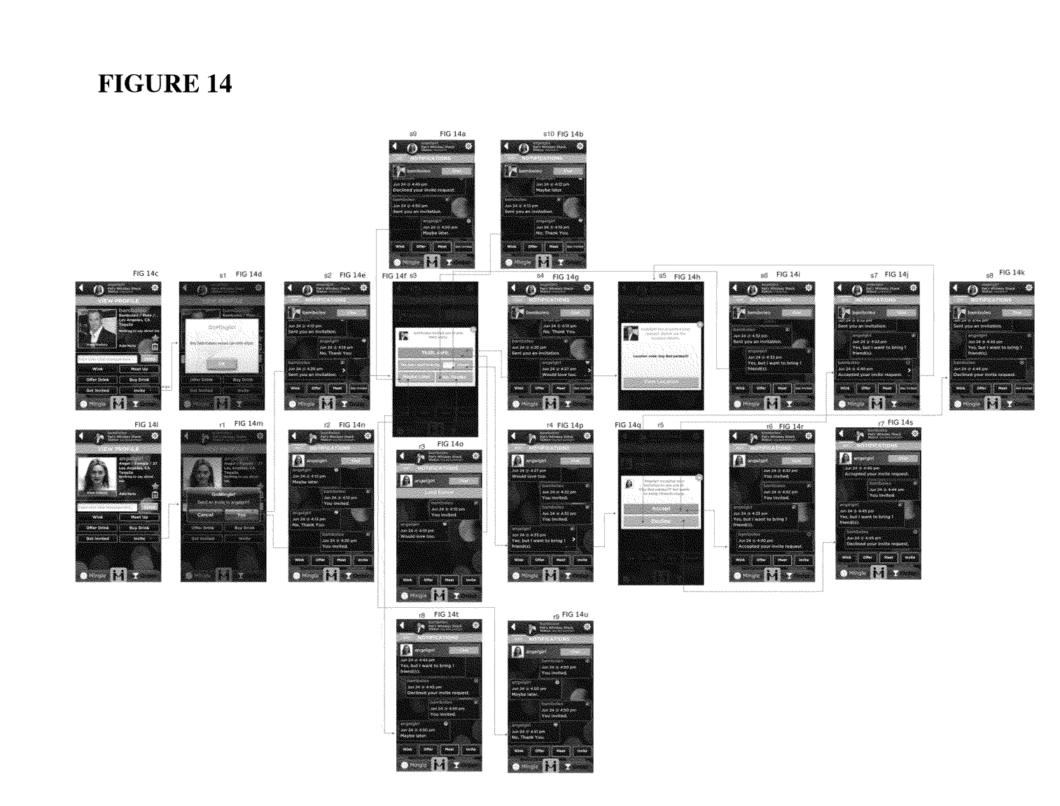

FIG. 14 is a diagram flowchart of the ‘Invite’ module built into the embodiment of the present invention. This module begins by selecting the ‘invite option within a user's profile page (FIG. 14c/14l). This action may also be available through other action screens throughout the application.

FIG. 14d shows the pop up window stating that invites are limited to Table/Cabana owners only. The invite module requires that a user either purchase access to VIP area or have made a similar transaction that would grant them access to this module within the application. Otherwise this module is limited up to this point.

FIG. 14m shows the pop up dialog confirming that the user wishes to send the invite request to the recipient. Once confirmed, the recipient will receive the action within their inbox (FIG. 14e). The user also receives a notification of their invite through their notification window (FIG. 14n).

FIG. 14f shows the pop up window with all the options accessible by the recipient upon selecting the invite within their notification window (Yeah Sure/Yes, but I want to bring a friend/Maybe later/No Thank You).

FIG. 14o shows the response message sent to the user when the recipient clicks on the ‘Yeah Sure’ option.

FIG. 14p shows the response message sent to the user when the recipient clicks on the ‘Yes, but I want to bring a friend’ option. In the initial pop up window the receipt may change the number of ‘friends’ they would like to bring along. This number is integrated into the message sent to the user. The user may then select the message and receive a pop window (FIG. 14q) with their available response options (Accept/Decline).

FIG. 14r shows the response message sent to the recipient when the user clicks on the ‘Accept’ option.

FIG. 14x shows the response message sent to the recipient when the user clicks on the ‘Decline’ option.

FIG. 14t shows the response message sent to the user when the recipient clicks on the ‘Maybe Later’ option.

FIG. 14u shows the response message sent to the user when the recipient clicks on the ‘No Thank You’ option.

FIG. 15 is a diagram flowchart of the ‘get invited’ module built into the embodiment of the present invention. This module begins by selecting the ‘get invited’ option within a user's profile page (FIG. 15a). This action may also be available through other actions screen throughout the application.

FIG. 15b shows the pop up window stating that invites are limited to Table/Cabana owners only. The get invite module requires that a recipient either purchase access to committable area or have made a similar transaction that would grant them access to this module within the application. Otherwise this module is limited up to this point.

FIG. 15c shows the pop up dialog confirming that the user wishes to send the get invite request to the recipient. Once confirmed, the recipient will receive the action within their inbox (FIG. 15j). The user also receives a notification of their invite through their notification window (FIG. 15d).

In the initial pop up window (FIG. 15c) the user may change the number of ‘friends’ they would like to bring along. This number is integrated into the message sent to the recipient. The recipient may then select the request and receive a pop window (FIG. 15l) with their available response options (Accept/Decline).

FIG. 15f shows the notification sent to the user when the recipient grants their get invited request. The user may then select the invitation and view a pop-up window (FIG. 15g) containing the table/cabana information. A ‘View location’ option allows the user to locate the table/cabana on a venue map (FIG. 15h).

FIGS. 15n/15i show the notifications sent to both the user and the recipient when the get invited request is declined.

The following figures represent the administrator panel interface that is integrated into the software application of the illustrated embodiment. The administrative panel incorporates several of the inventive concepts detailed above. Initial login screens will be discussed along with the various option screens that are integrated into the panel system.

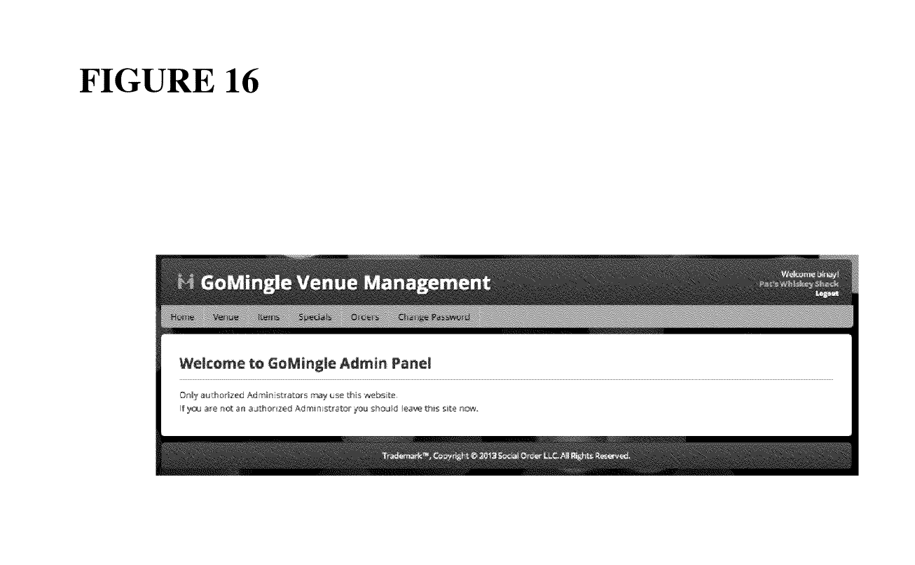

FIG. 16 is an illustrative screenshot of the administrative panel landing page within an embodiment of the present invention. Several elements of the landing page, including the title bar and the option buttons along the top of the screen, are incorporated into the remaining screen shots.

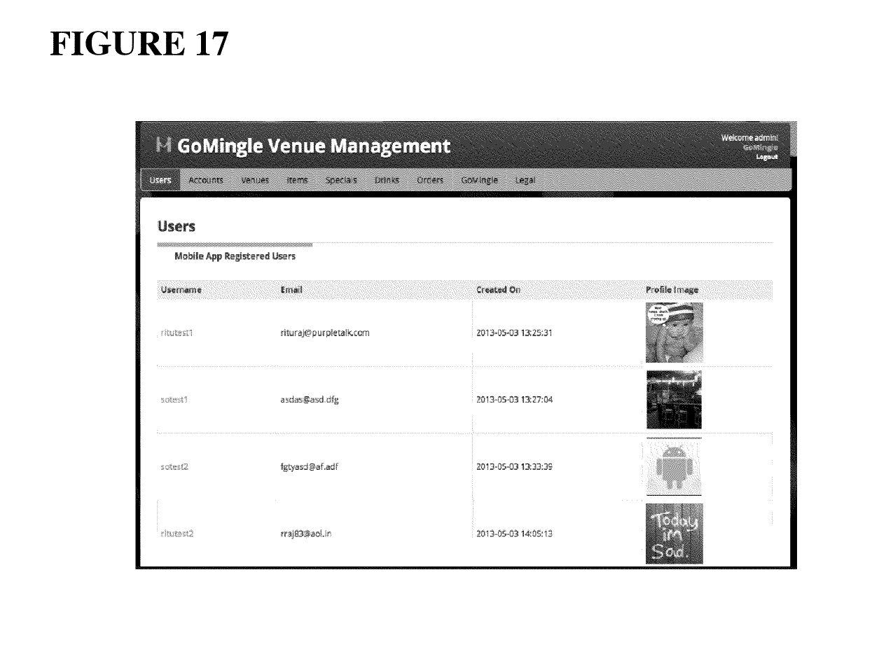

FIG. 17 is an illustrative screenshot of the administrative panel user's screen within an embodiment of the present invention. This screen shot will show the administrators the active users attached to a venue at that moments along with their relevant user information (username/email/account create date/profile image). Note that this registered users list will be modified in accordance the use patterns of the users within the system.

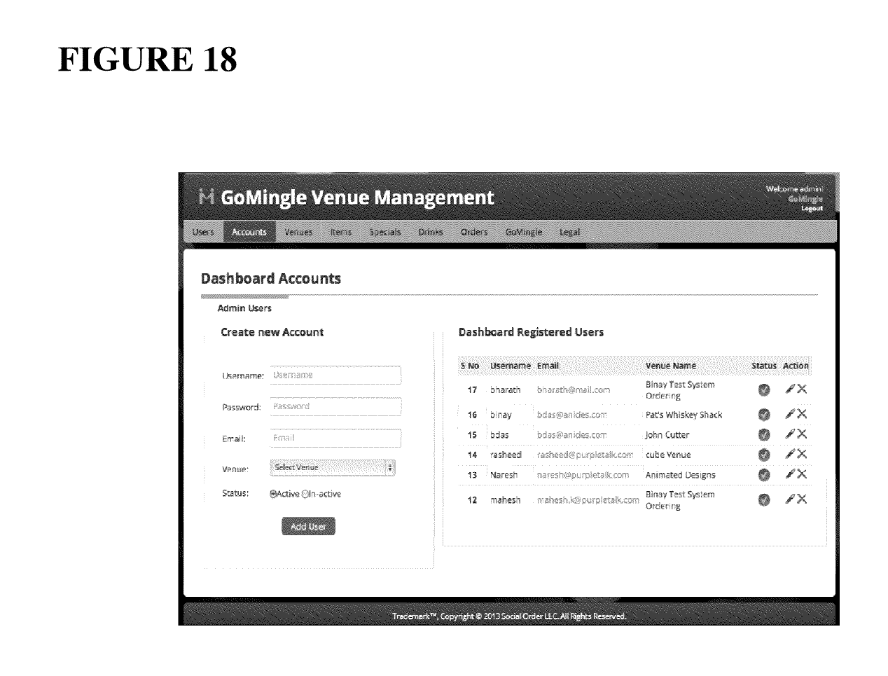

FIG. 18 is an illustrative screenshot of the administrative panel accounts dashboard within an embodiment of the present invention. This dashboard allows for the creation of addition administrator accounts in order to manage the venue specific elements within the system. A ‘create new account’ dashboard sits on the left side along with a listing of user on the right. Each administrator account is identified by username/email/venue/and status within the system. Action buttons also follow with each administrator account in order to make changes to their settings.

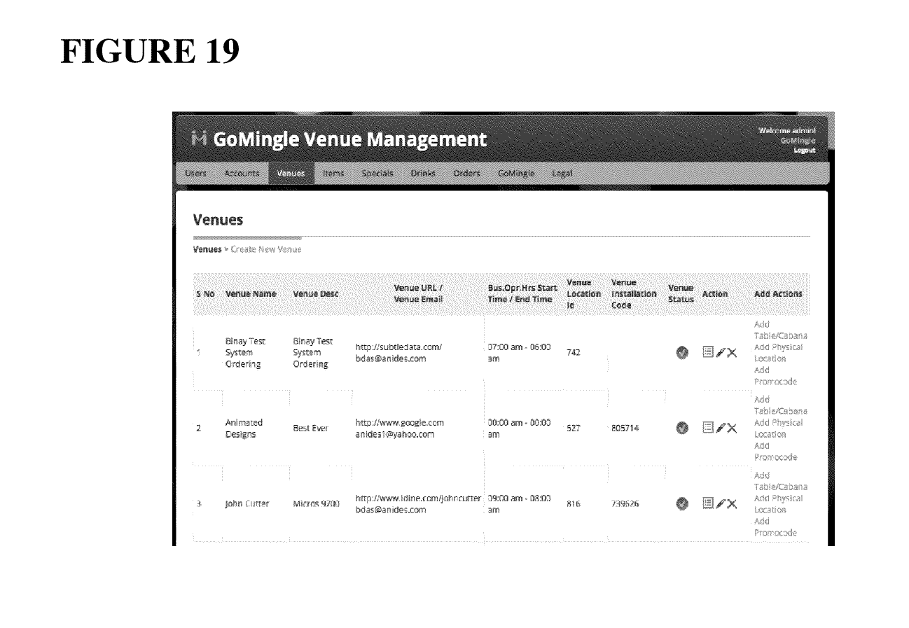

FIG. 19 is an illustrative screenshot of the administrative panel venues screen within an embodiment of the present invention. Each Venue is listed with pertinent venue information alongside (Venue Name/Venue Description/Venue URL/Business Hours/Location ID/Installation code/Status). Alongside the identification information, each Venue has a series of action command in order to make modifications (Add Table/Cabana/Add Physical Location/Add Promo Code).

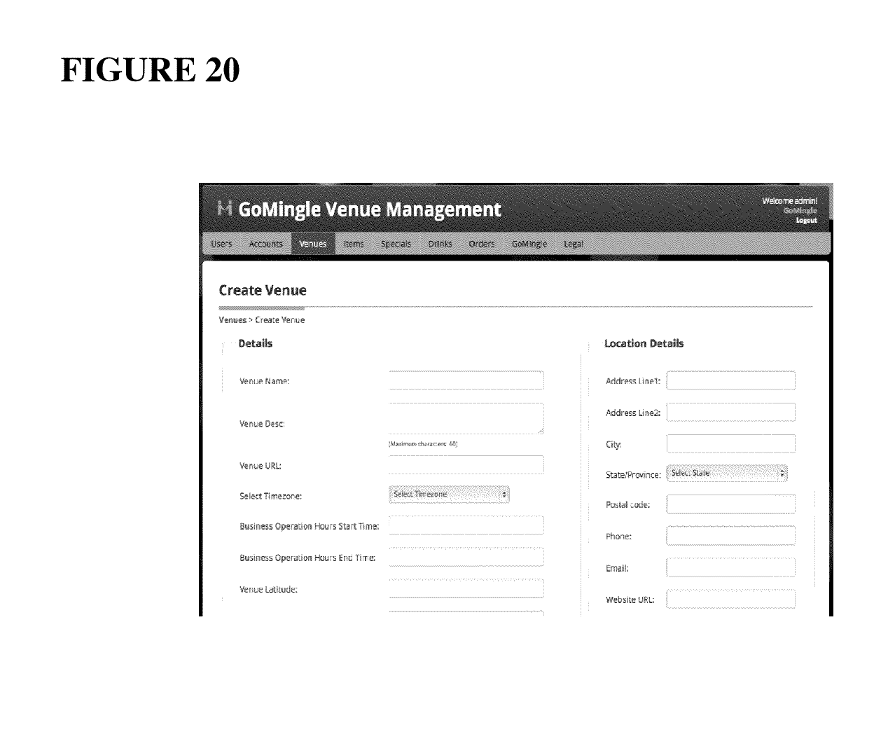

FIG. 20 is an illustrative screenshot of the administrative panel ‘create venue’ screen within an embodiment of the present invention. Here an administrator may add all of the detailed information related to a particular venue in order to populate all the interactive element of the mobile application. Once completed, the venue will be added a listed venue on FIG. 19.

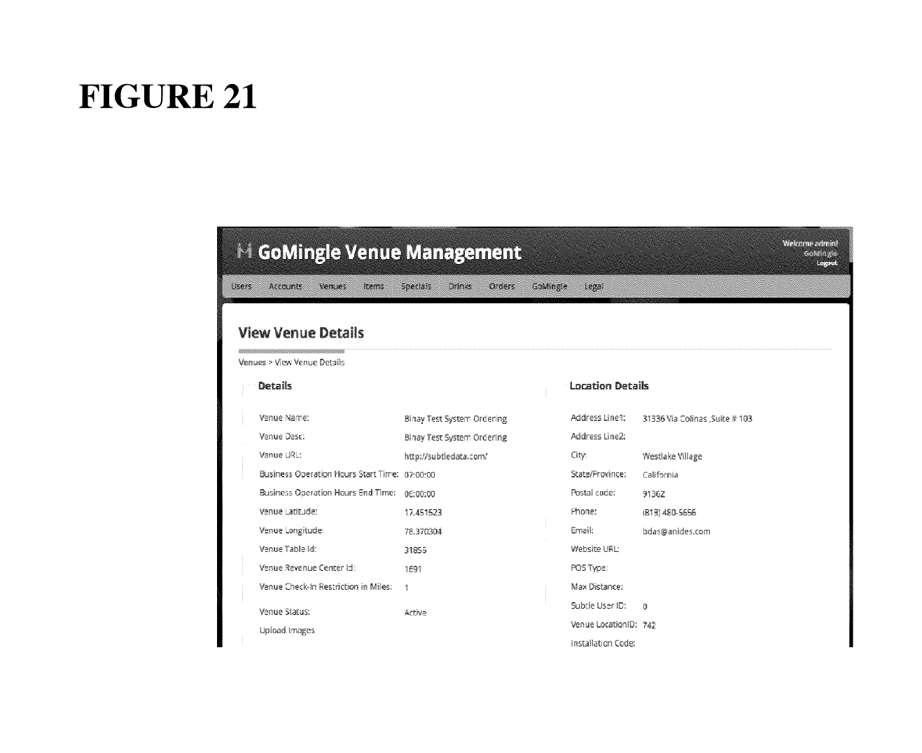

FIG. 21 shows a completed listing a particular venue's information once it has been inputted into the system.

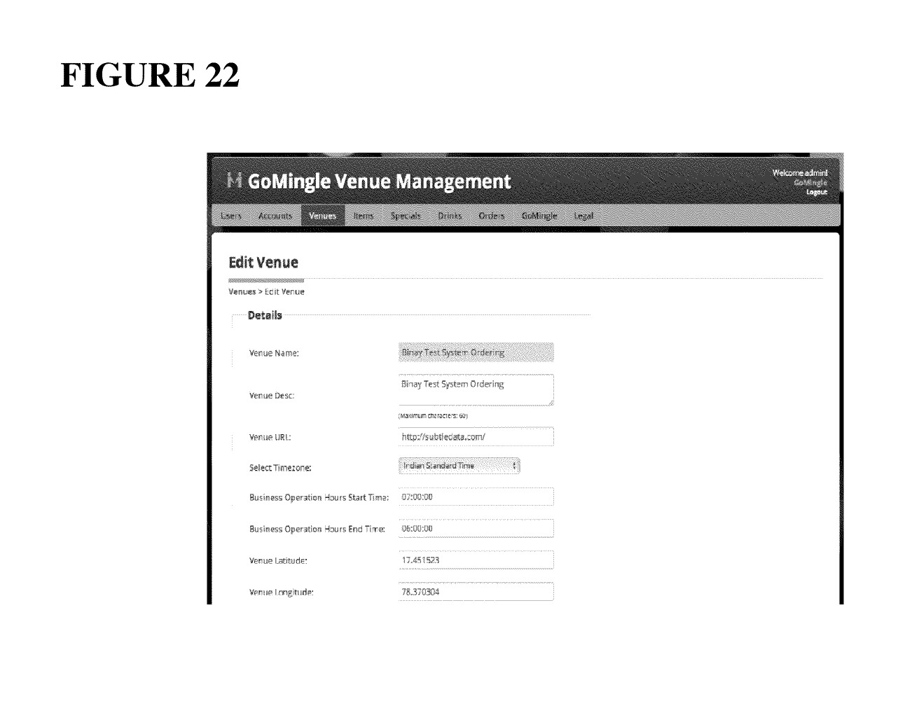

FIG. 22 is an illustrative screenshot of the administrative panel ‘edit venue’ screen within an embodiment of the present invention. All information related to a venue may be modified in real-time in order to re-populate the information within the mobile application.

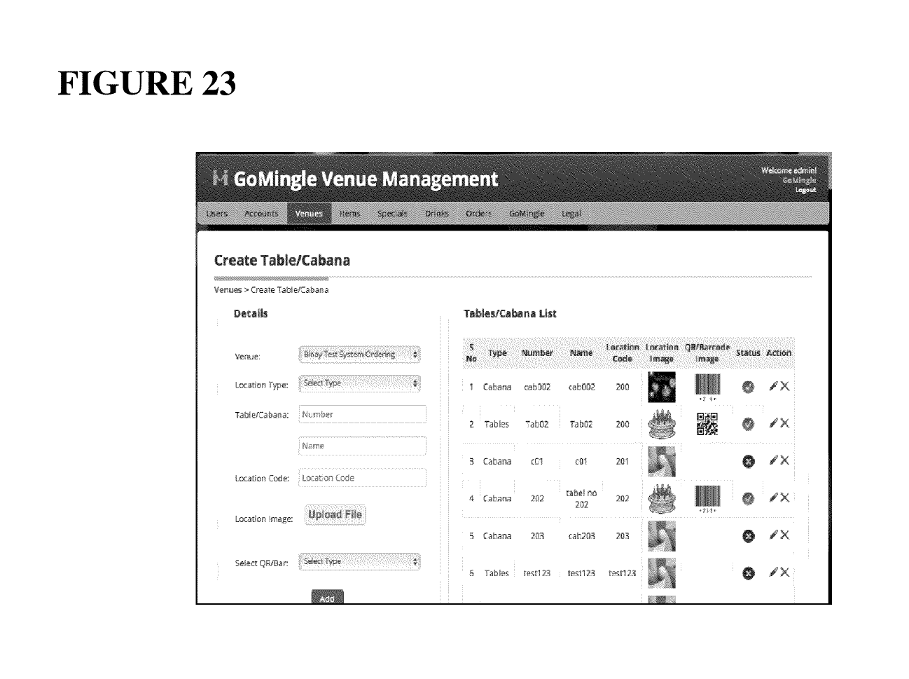

FIG. 23 is an illustrative screenshot of the administrative panel ‘create table/cabana’ screen within an embodiment of the present invention. On the left side of the screen, the details of a particular table/cabana may be added to a venue. On the right side of the screen, the administrative panel maintains a list of all the available tables/cabanas within a venue. All of their identify information is detailed from left to right for each table/cabana (ID number/Type/Number/Name/Location Code/Image/QR Barcode image/Status). Action buttons are also attached alongside each table/cabana in order to modify their details.

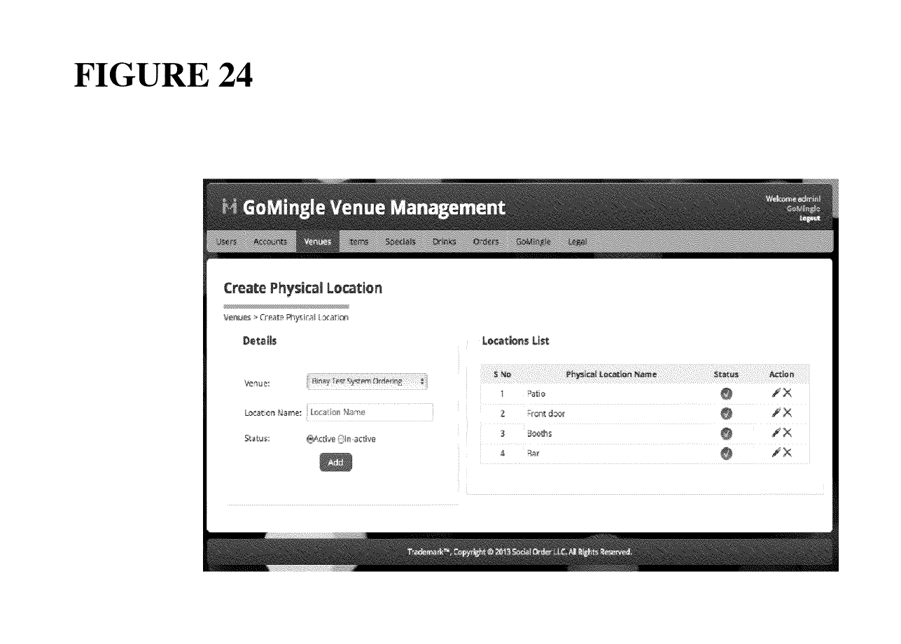

FIG. 24 is an illustrative screenshot of the administrative panel ‘create physical location’ screen within an embodiment of the present invention. On the left side of the screen, the details of a particular physical location may be added to a venue. On the right side of the screen, the administrative panel maintains a list of all the available physical locations within a venue. All of their identify information is detailed from left to right for each physical location (Number/physical location name/Status). Action buttons are also attached alongside each physical location in order to modify their details.

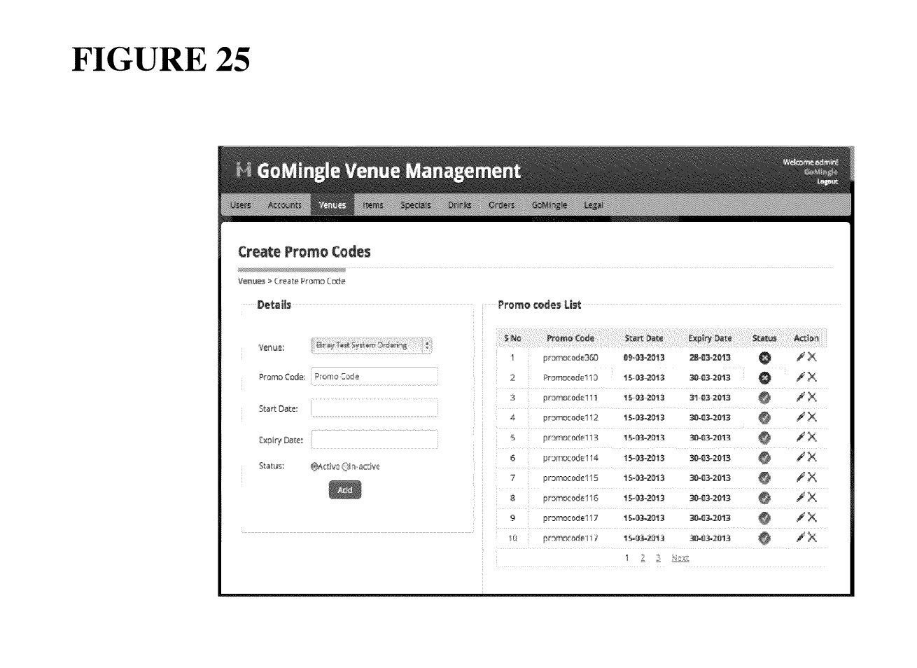

FIG. 25 is an illustrative screenshot of the administrative panel ‘create promo codes’ screen within an embodiment of the present invention. On the left side of the screen, the details of a particular promotional code may be added to a venue. On the right side of the screen, the administrative panel maintains a list of all the available promotional codes within a venue. All of their identify information is detailed from left to right for each promotional code (Number/promotional code/start data/expiry date/Status). Action buttons are also attached alongside each promotional code in order to modify their details.

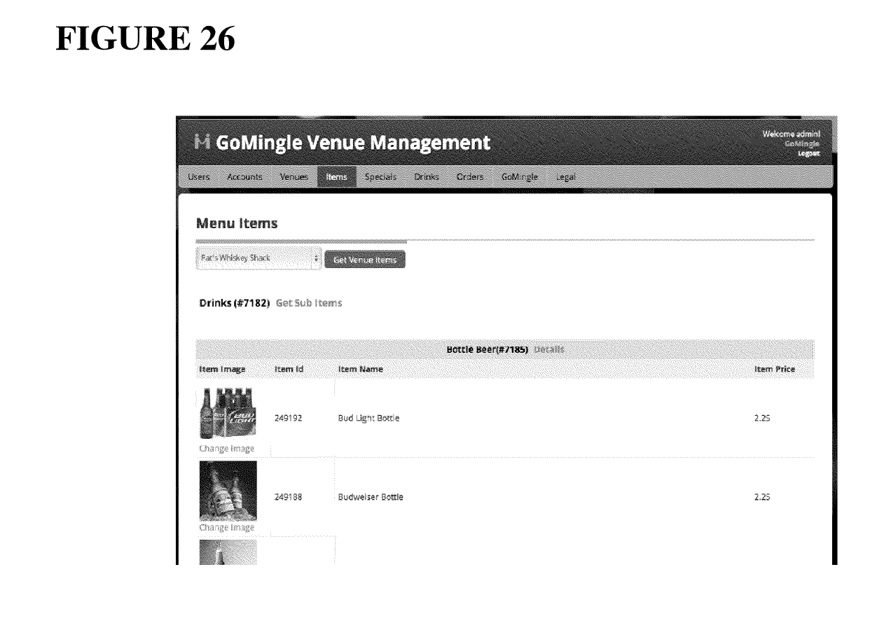

FIG. 26 is an illustrative screenshot of the administrative panel ‘Items’ screen within an embodiment of the present invention. This menu allows an administrator to add additional items that may not apply to the ‘Specials’ or ‘Drinks’ sections. Each item is listed with their corresponding information (Image/Item ID/Item Name/Item Price).

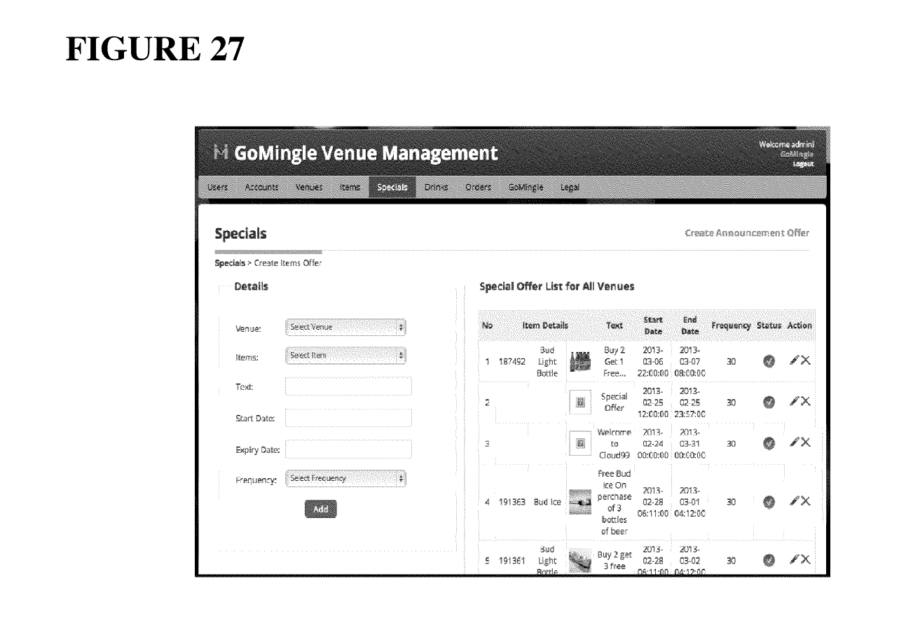

FIG. 27 is an illustrative screenshot of the administrative panel ‘Specials’ screen within an embodiment of the present invention. On the left side of the screen, the details of a particular special may be added to a venue. On the right side of the screen, the administrative panel maintains a list of all the available specials within a venue. All of their identify information is detailed from left to right for each special (Number/Item Details/Image/Text/Start Date/End Date/Frequency/Status). Action buttons are also attached alongside each special in order to modify their details.

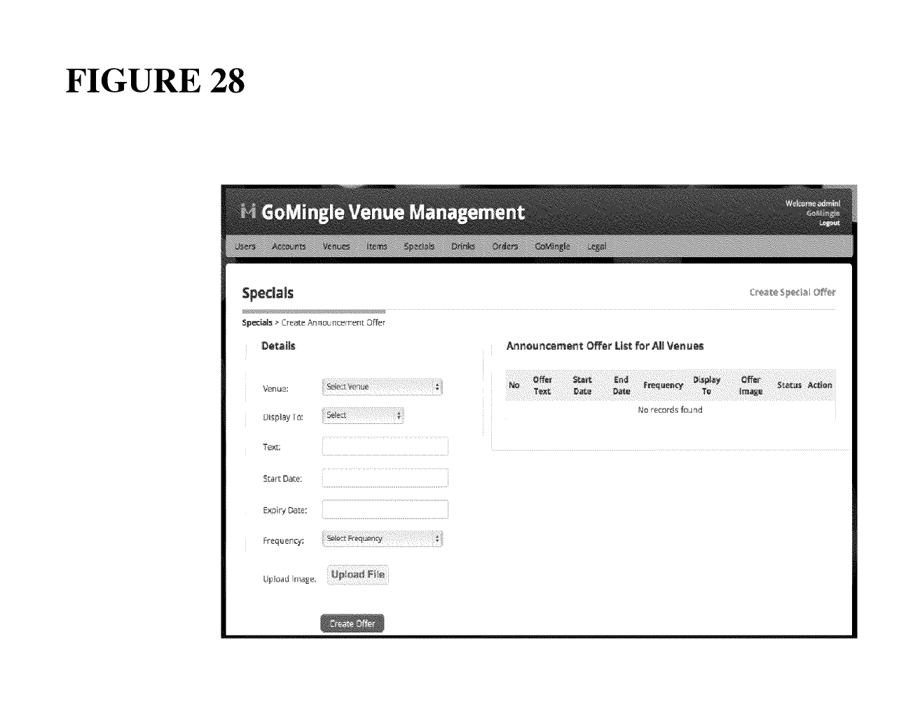

FIG. 28 is an illustrative screenshot of the administrative panel ‘Create Announcement Offer’ screen within an embodiment of the present invention. The functionality of this administrative screen is analogous to that of the ‘specials’ screen.

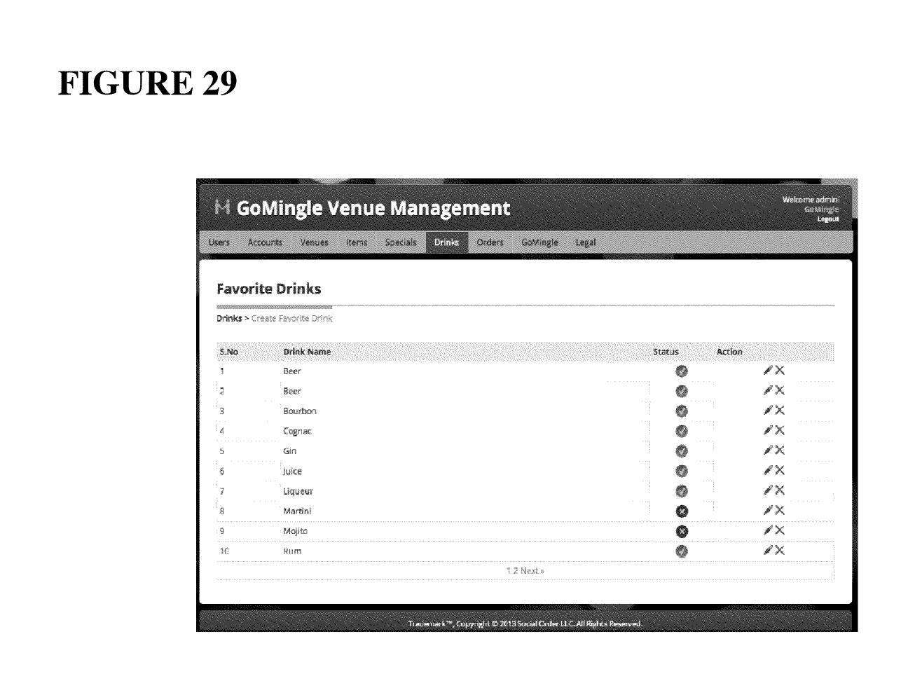

FIG. 29 is an illustrative screenshot of the administrative panel ‘Favorite Drinks’ screen within an embodiment of the present invention. All the favorite drinks are listed in descending order along with their identifying information alongside (Number/Drink Name/Status). Action buttons are also attached alongside each favorite drink in order to modify their details.

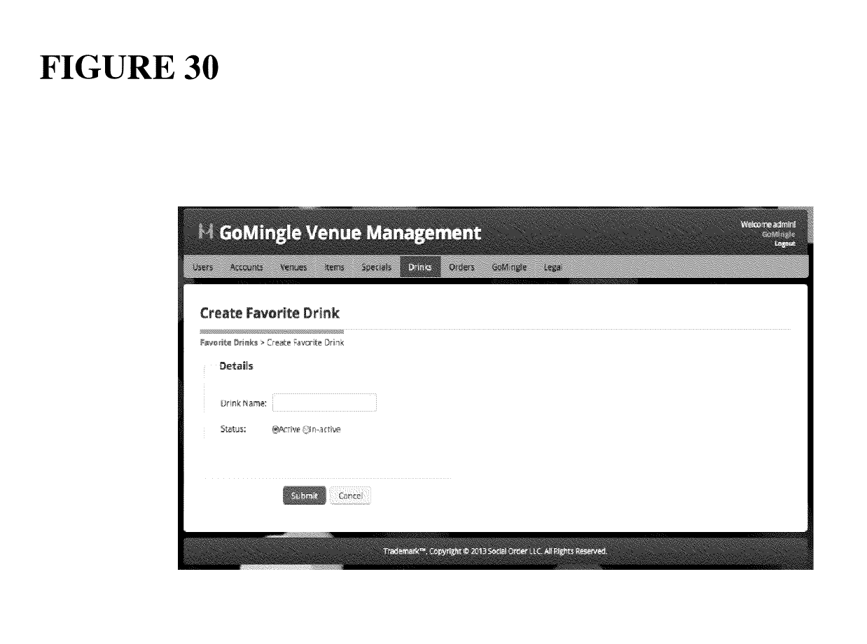

FIG. 30 is an illustrative screenshot of the administrative panel ‘Create Favorite Drink’ screen within an embodiment of the present invention. On the left side of the screen, the details of a particular favorite drink may be added to a venue.

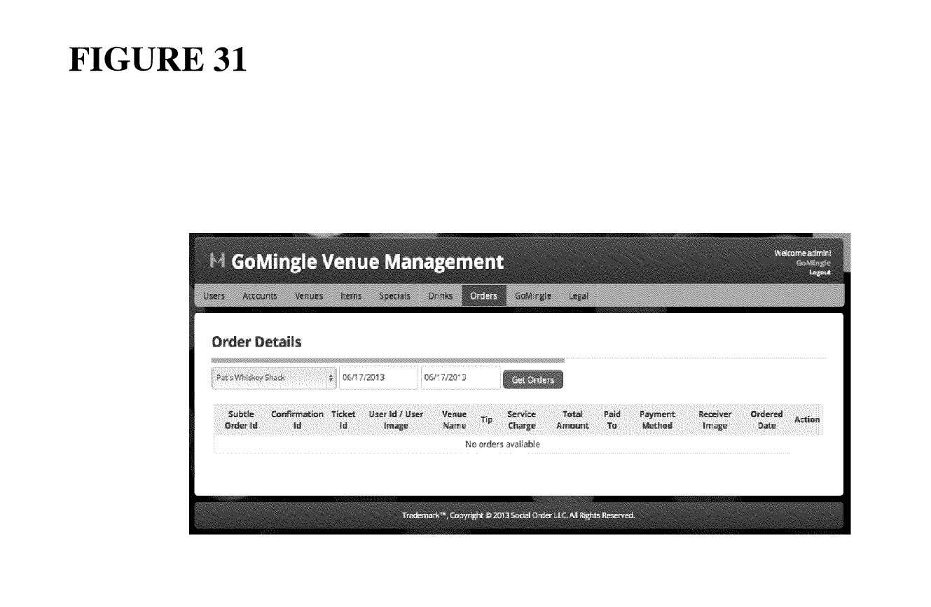

FIG. 31 is an illustrative screenshot of the administrative panel ‘Order Details’ screen within an embodiment of the present invention. All the orders are listed in descending order along with their identifying information alongside (Subtle Order ID/Confirmation ID/Ticket ID/User ID/User Image/Venue Name/Tip/Service Charge/Total Amount/Paid to/Payment Method/Receiver Image/Ordered Date/Action).

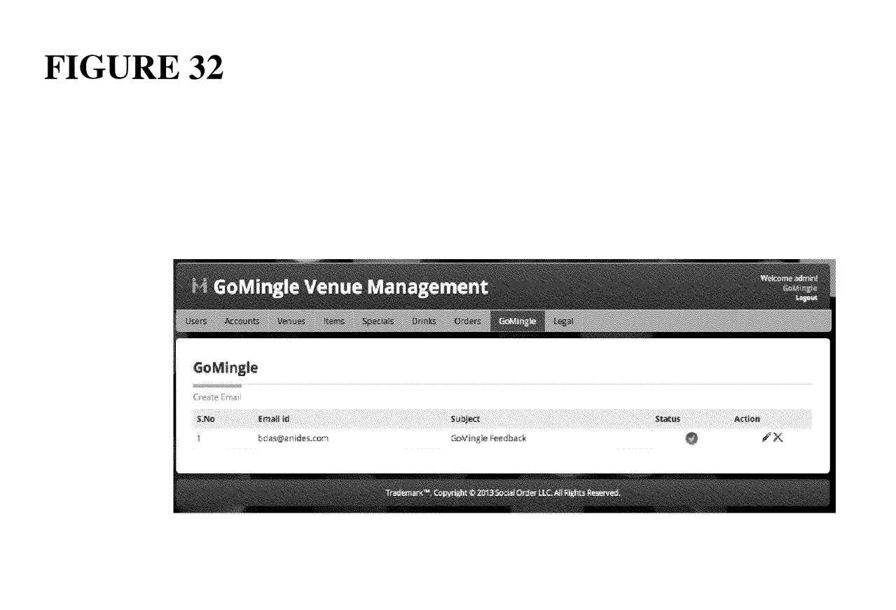

FIG. 32 is an illustrative screenshot of the administrative panel ‘GoMingle’ landing screen within an embodiment of the present invention. All the contact emails are listed in descending order along with their identifying information alongside (Number/email ID/subject email/Status). Action buttons are also attached alongside each contact email in order to modify their details. Additional email servers connect through this administrative panel in order to receive these contact emails into the panel.

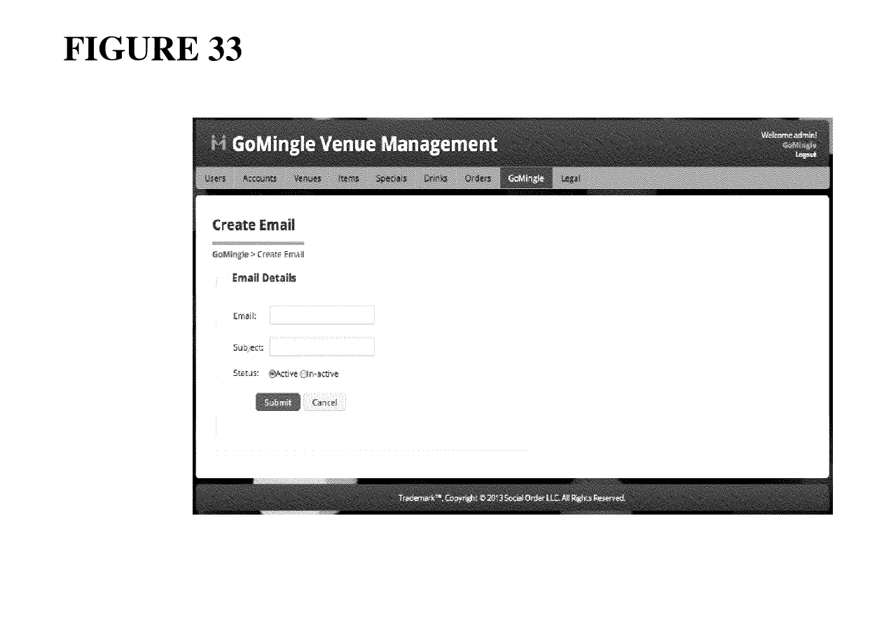

FIG. 33 is an illustrative screenshot of the administrative panel ‘Create Email’ screen within an embodiment of the present invention. On the left side of the screen, the details of a contact email may be added to a venue. Furthermore, the contact emails may be activated or deactivated for management purposes within the venue.

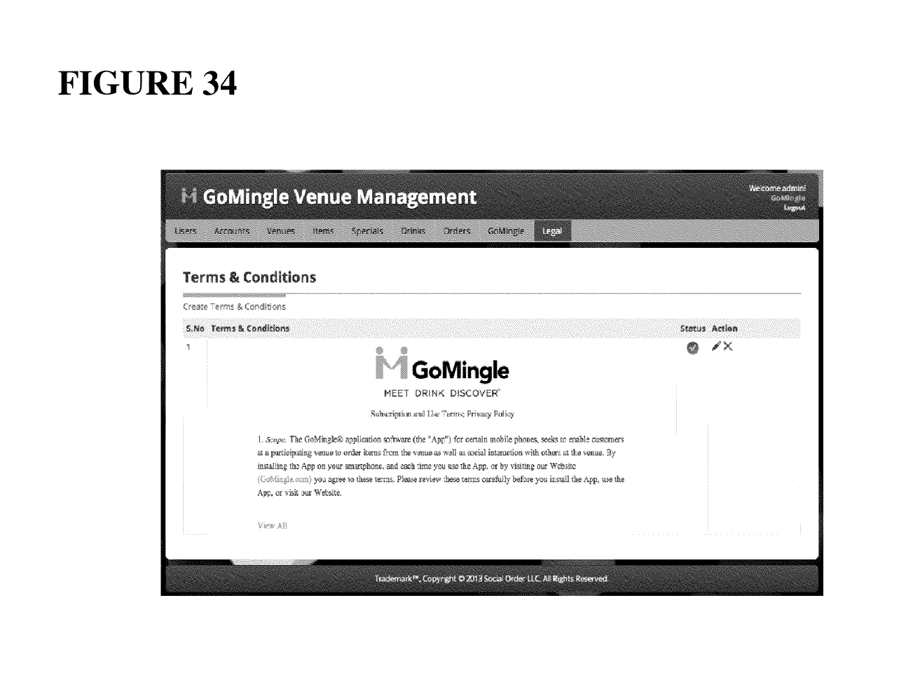

FIG. 34 is an illustrative screenshot of the administrative panel ‘Terms & Conditions’ screen within an embodiment of the present invention. All the terms and conditions are listed in descending order along with their identifying information alongside (Number/terms and conditions/Status). Action buttons are also attached alongside each set of terms and conditions in order to modify their details.

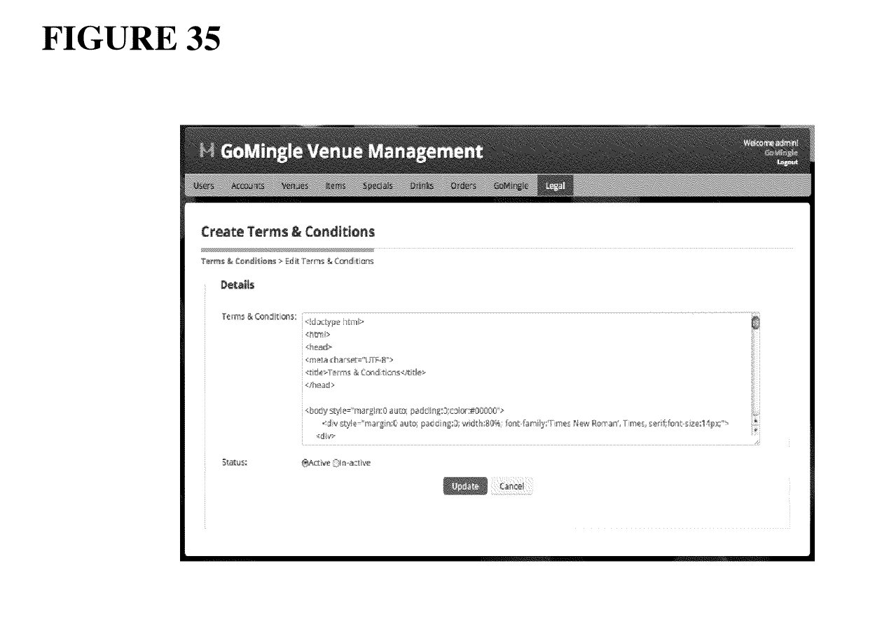

FIG. 35 is an illustrative screenshot of the administrative panel ‘Create Terms & Conditions’ screen within an embodiment of the present invention. An input window allows for the modification of terms and services along with an update button on the bottom of the panel.

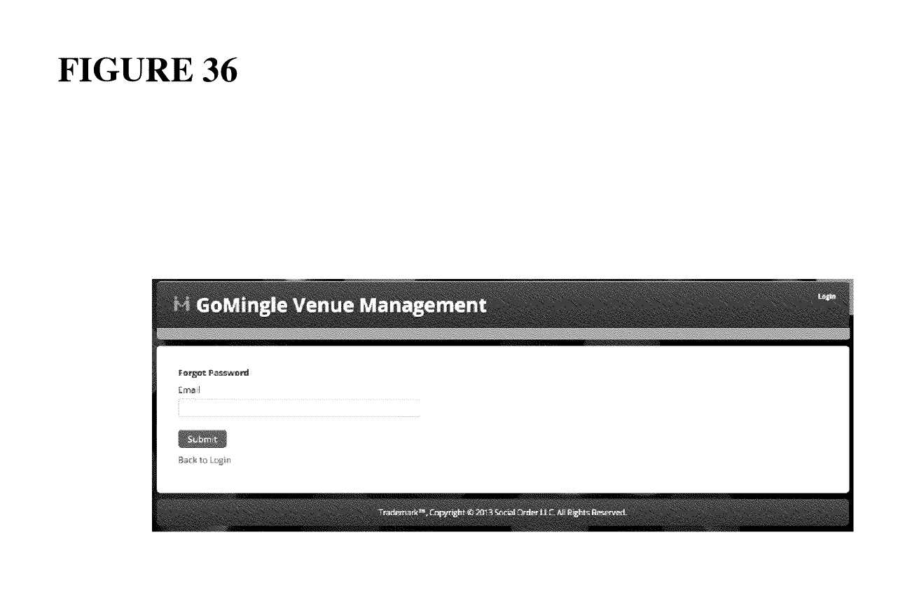

FIG. 36 is an illustrative screenshot of the administrative panel ‘Forgot Password’ screen within an embodiment of the present invention. The screen allows for an input window along with a submit button along the bottom of the screen.

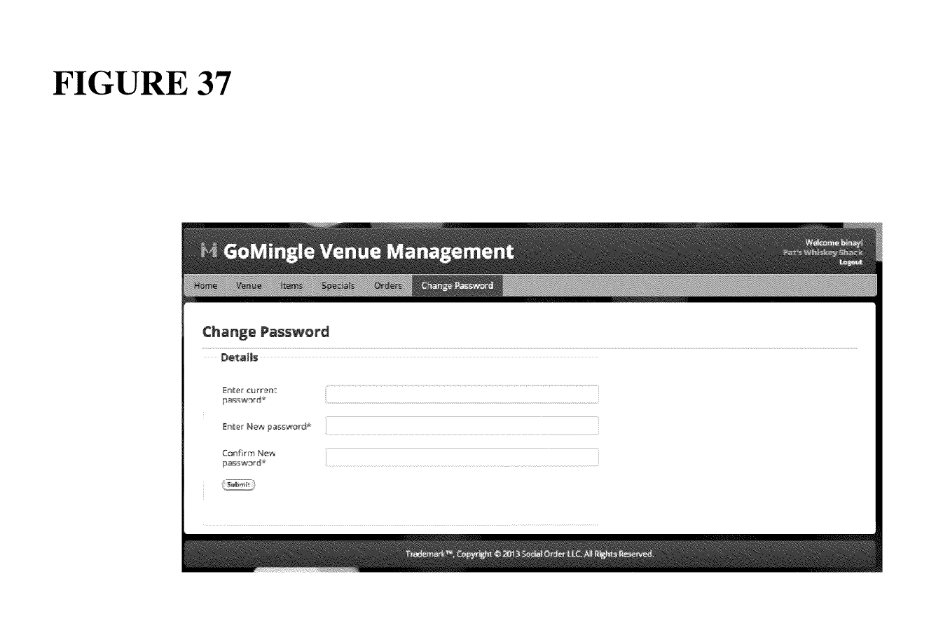

FIG. 37 is an illustrative screenshot of the administrative panel ‘Change Password’ screen within an embodiment of the present invention. Dual input windows, along with a submit button, are incorporated into the screen.

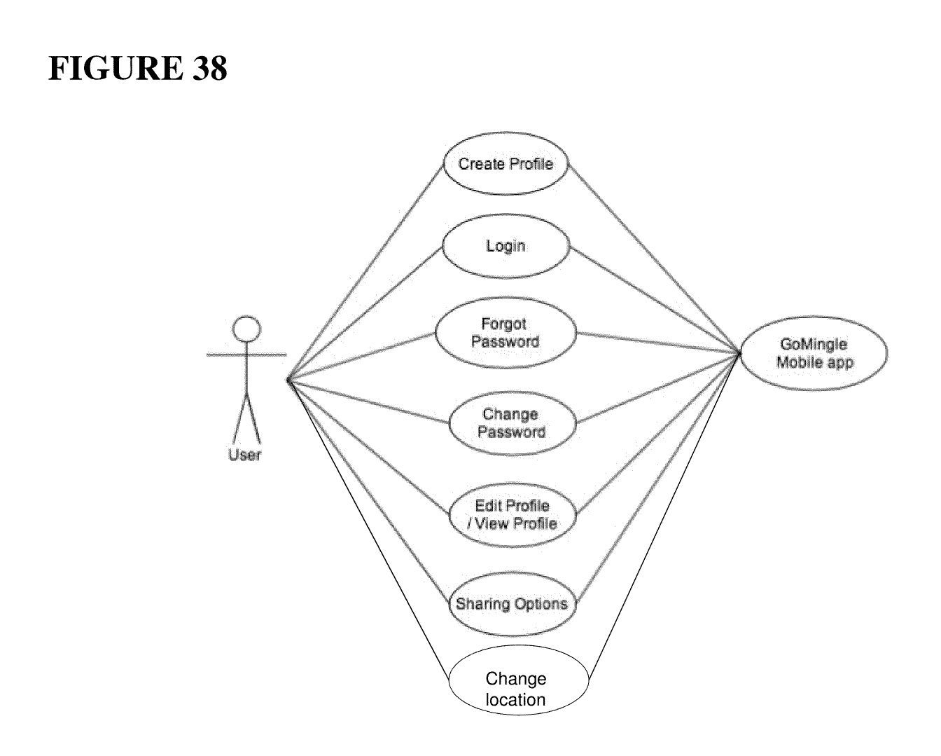

FIG. 38 is a diagram of the accounts module within an embodiment of the present invention.

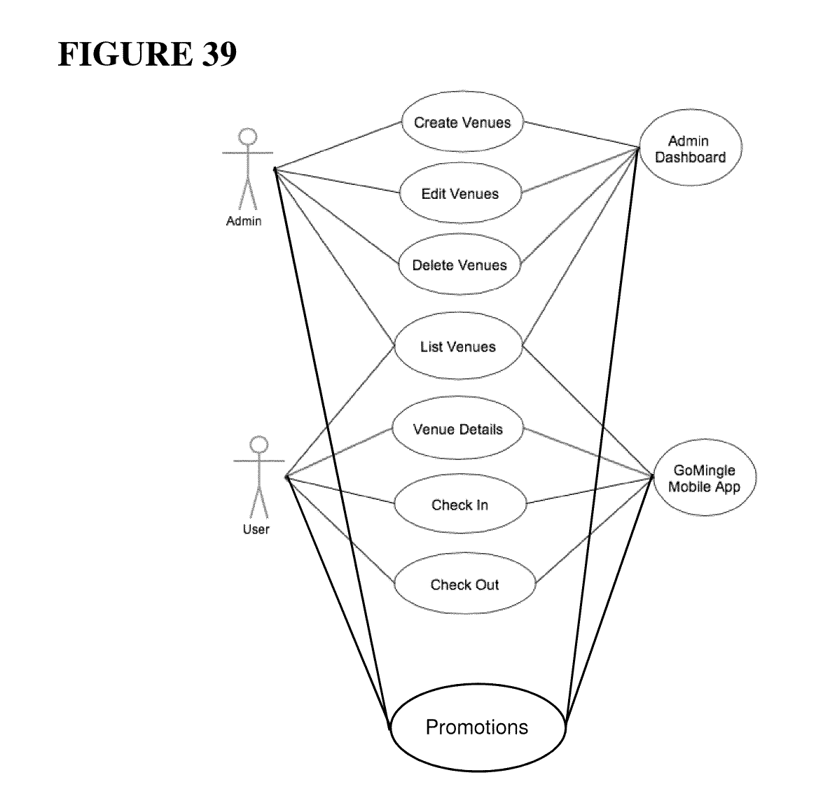

FIG. 39 is a diagram of the venues module within an embodiment of the present invention.

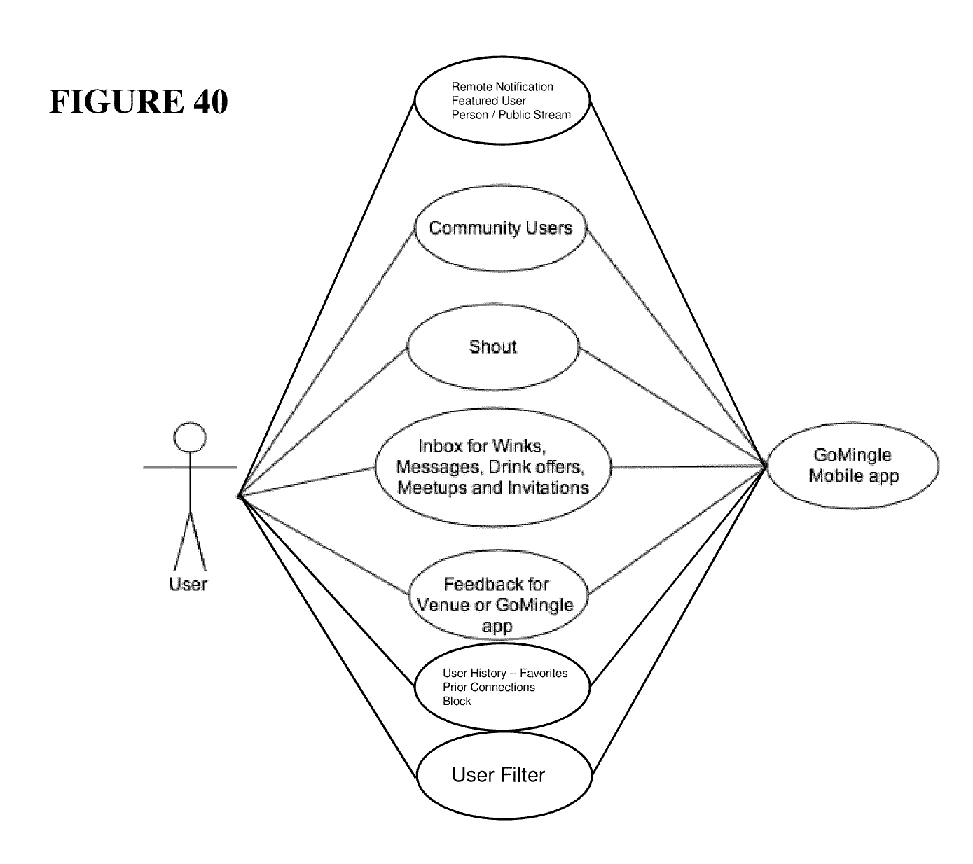

FIG. 40 is a diagram of the community module within an embodiment of the present invention.

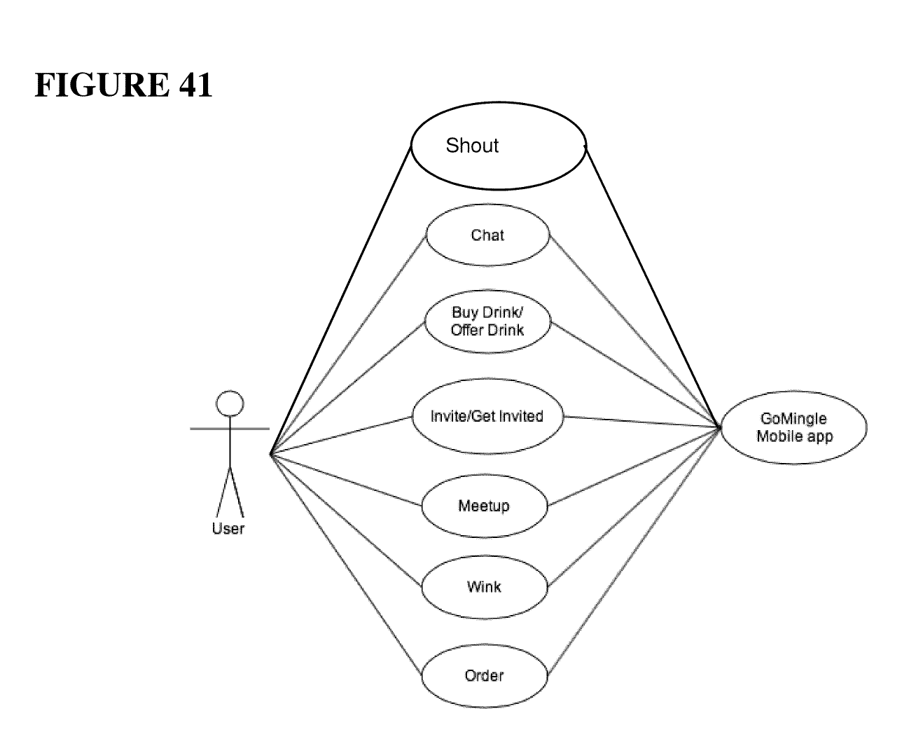

FIG. 41 is a diagram of the user and order module within an embodiment of the present invention.

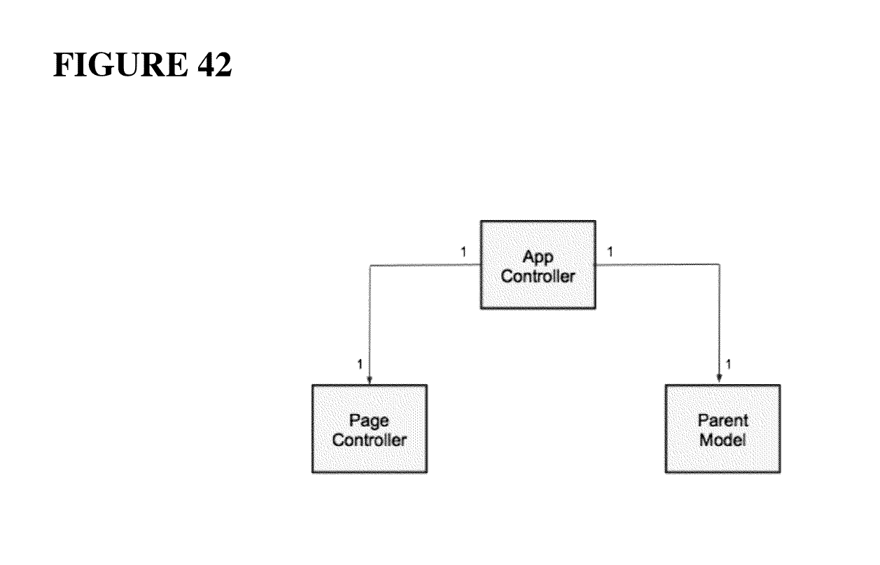

FIG. 42 is a diagram of the model view relationship within an embodiment of the present invention.

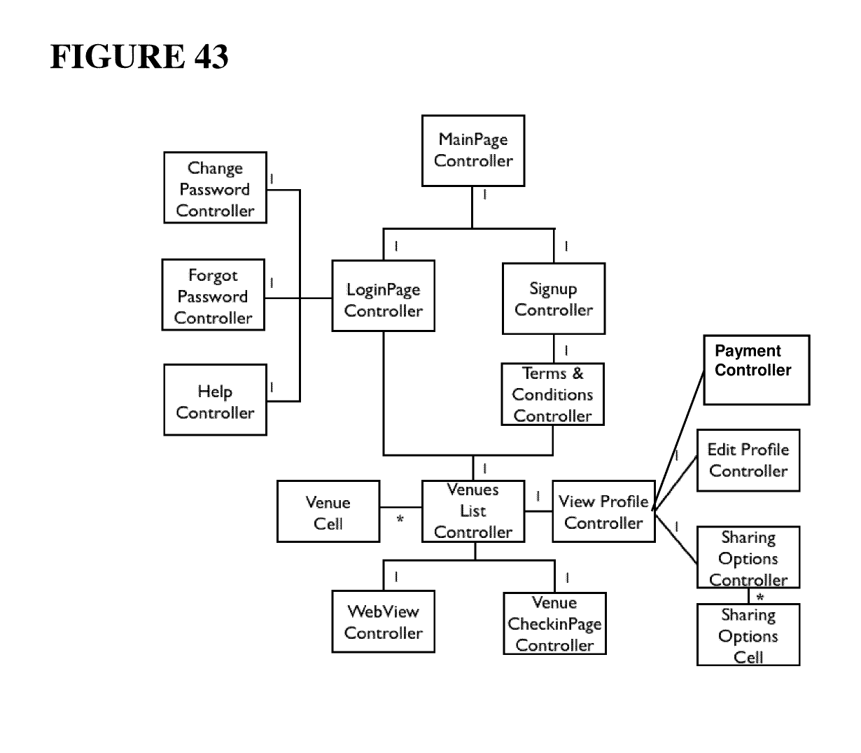

FIG. 43 is a diagram of the view relationship within an embodiment of the present invention.

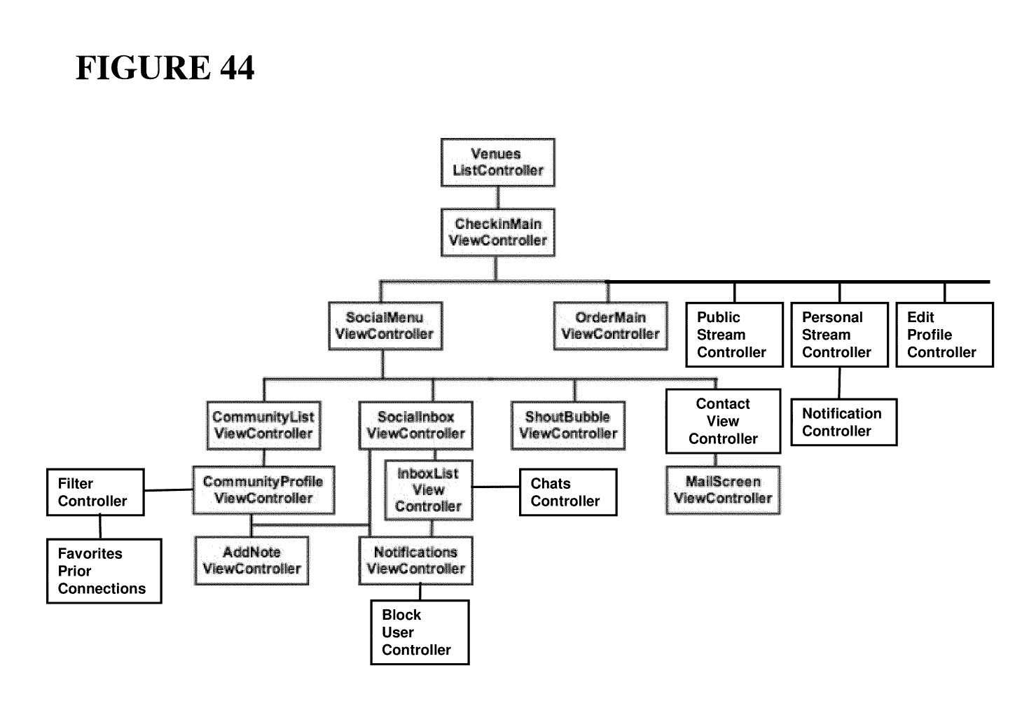

FIG. 44 is an alternate diagram of the view relationship within an embodiment of the present invention.

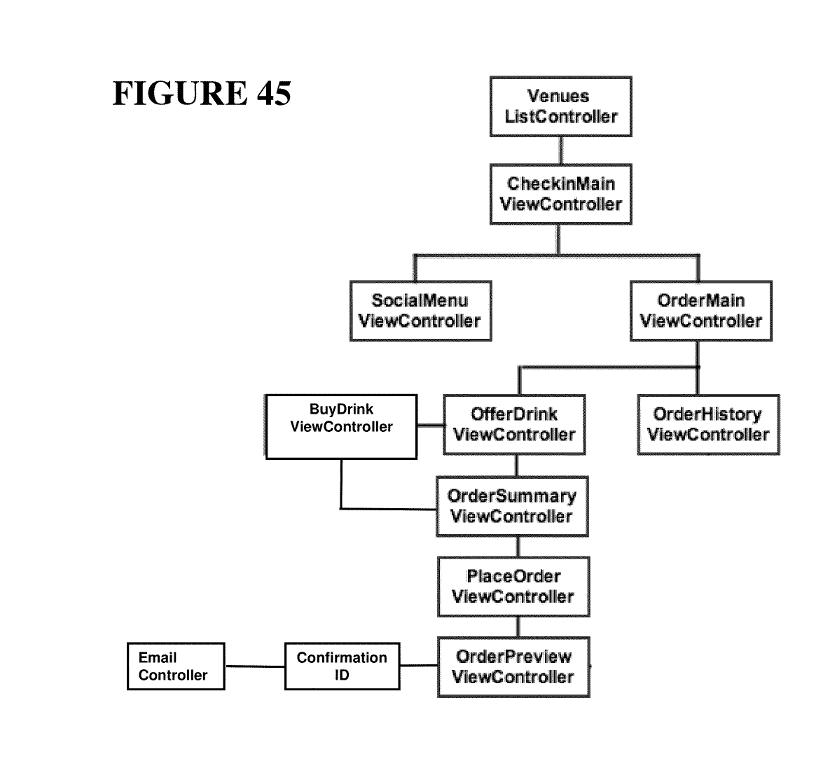

FIG. 45 is an alternate diagram of the view relationship within an embodiment of the present invention.

Exemplary embodiments of these systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the system and method as described herein.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention may be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A system for generating location-based communication and interaction features comprising:
a database containing first and second location elements, a feature set, and a first unique identifier associated with the second location element;
a system controller coupled to the database and configured to establish the first location element with a first physical location, establish the second location element with a second physical location and associate the first unique identifier with the second location element; and
a user interface configured to couple a first user device with the system controller, the first user device being associated with the first location element; and the system controller being further configured to transmit an initiated action between the first and second user, to transmit the unique identifier to the first user in relation to the action from the second user, and to associate the first user with the second location element based on the possession of the unique identifier by the first user after transmission.

2. The system, as in claim 1, the system controller further configured to allow an administrator to make modifications to the first and second location elements.

3. The system, as in claim 2, the modifications to the first and second location elements being tied to the dimensions of the first and second physical spaces.

4. The system, as in claim 2, the modifications to the first and second location elements being tied to the association of the first user interface to the first and second location elements.

5. The system, as in claim 4, each modification being further dependent on a number of unique identifiers associated with the first and second location elements.

6. The system, as in claim 1, the system controller further configured to allow an administrator to perform any of the following:
remove a location element from the database;
add a third location element to the database;
modify the feature set;
remove a feature set from the database;
add a feature set to the database;
remove a unique identifier from the database; or
add a unique identifier to the database.

7. The system, as in claim 6, each feature set containing a plurality of features, the system controller further configured to allow an administrator to modify the number of features from the features set.

8. The system, as in claim 7, at least one feature configured to grant a method of communication between the first user device and the second user device associated with the first and second location elements.

9. They system, as in claim 7, at least one feature configured to provide a particular transaction to the first and second user device associated with the first and second location elements.

10. The system, as in claim 1, the database further including a plurality of metrics tied to a user, the system controller further configured to modify a total sum of unique identifiers within the database and available to a user of the first user device in order to grant access to the second location element as a function based on the metrics within the database.

11. The system, as in claim 1, the system controller configured to require a prior predetermined action from the feature set initiated between a user of the first user device and a user of the second user device prior to associating the first unique identifier to the first user device.

12. The system, as in claim 11, the system controller configured to allow an administrator to modify which predetermined prior action required between the user of the first user device and the user of the second user device prior to associating the first unique identifier to the first user device.

13. A method for generating location-based communication and interaction features including a database having a first and second location element, a feature set including at least one action, a first unique identifier, the method further including a system controller and a user interface and a second user interface and comprising the steps of:
establishing the first location element with a first physical location through the system controller;
associating the first location element with a first user interface;
association the second location with a second user interface;
coupling the first user device with the system controller through the user interface;
coupling the second user device with the system controller through the user interface;
transmitting an action from within the feature set between the first user and the second user;
transmitting the unique identifier to the first user in relation to the response to the action from the second user; and
granting the user of the first user device access to the second feature set and the second location element based on the association with the first unique identifier.

14. The method, as in claim 13, further including the step of allowing an administrator to make modifications to the first and second location elements.

15. The method, as in claim 14, the modifications to the first and second location elements being tied to the dimensions of the first and second physical spaces.

16. The method, as in claim 14, the modifications to the first and second location elements being tied to the association of the first user interface to the first and second location elements.

17. The method, as in claim 14, each modification being further dependent on a number of unique identifiers associated with the first and second location elements.

18. The method, as in claim 17, further including the step of allowing an administrator to perform the following:
remove the first and second location elements from the database;
add a third location element to the database;
modify the feature set;
remove a feature set from the database;
add a feature set to the database;
remove a unique identifier from the database; or
add a unique identifier to the database.

19. The method, as in claim 13, each feature set containing a plurality of features, further including the step of allowing an administrator to modify the number of features from the features set.

20. The method, as in claim 19, wherein at least one feature grants a method of communication between the user devices associated with the first and second location elements.

21. The method, as in claim 19, wherein at least one feature grants a particular transaction for the user devices associated with the first and second location elements.

22. The method, as in claim 13, the database further including a plurality of metrics tied to each user, further including the step of allowing an administrator to modify a total sum of unique identifiers within the database and available to a user of the first user device in order to grant access to the second location element as a function based on the metrics within the database.

23. The method, as in claim 13, further including the step of allowing an administrator to modify the predetermined prior action required between the user of the first user device and the user of the second user device.

24. The method, as in claim 13, further including the step of granting a predetermined number of unique identifiers to the user of the second user device.

25. The method, as in claim 13, further including the step of allowing an administrator to modify the number of unique identifiers available to the user of the second user device as a function of a prior action from a feature set initiated by the user of the second user device.

26. A non-transitory information recording medium on which a computer readable program is recorded that causes a computer to function as a system comprising:
a database containing first and second location elements, a feature set, and a first unique identifier associated with the second location element;
a system controller coupled to the database and configured to establish the first location element with a first physical location, establish the second location element with a second physical location and associate the first unique identifier with the second location element; and
a user interface configured to couple a first user device with the system controller, the first user device being associated with the first location element; and the system controller being further configured to allow the transmission of an initiated action between the first and second user, to transmit the unique identifier to the first user in relation to the action from the second user, and to associate the first user with the second location element based on the possession of the unique identifier by the first user after transmission.
